(19) United States
(12) Patent Application Publication
(10) Pub. No.: US 2012/0282884 A1
(43) Pub. Date: Nov. 8, 2012

(54) System and method for the emergency voice and image e-mail transmitter device

(76) Inventor: Nicholas Sun, Poughkeepsie, NY (US)

(21) Appl. No.: 13/068,225

(22) Filed: May 5, 2011

(51) Int. Cl. H04M 11/04

(52) U.S. Cl. 455/404.2

(57) ABSTRACT

A voice and image e-mail transmitter device with an external camera attachment that is designed for the emergency and surveillance purposes is disclosed. The device converts voice signals and photo images into digital format, which are transmitted to the nearest voice-image message receiving station from where the digital signal strings are parsed and converted into voice, image, or video message files which are attached to an e-mail and delivered to user pre-defined destination e-mail addresses and a 911 rescue team. The e-mail also includes the caller's voice and personal information, photo images of a security threat, device serial number, and a GPS location map of the caller's location. The digital signal data may be recorded and transmitted within few seconds. The victim's family or police may either check the GPS location map in an e-mail or apply a new GPS based people tracking system of the present invention to search for a missing victim.

### RELATED PATENT APPLICATION

This application is related to U.S. Pat. No. 7,751,534; assigned to the same assignee as the current invention and which is herein incorporated by reference in its entirety.

### FIELD OF THE INVENTION

The present invention relates to a voice and image transmitter device similar to a cellular phone which sends the frequencies of human voices and picture images in a digital signal format, and the transmitter device is equipped with an external camera, an external microphone, and a push button to provide a portable surveillance function for protecting people against violent crimes. It also relates to a system and method that converts the transmitted digital signal string into voice and image message files attached to an e-mail and delivers to the pre-defined destination e-mail addresses over the Internet for emergency and surveillance use, which includes a new improved GPS based people tracking system to assist family members and law enforcement agencies to search for the missing persons who may be the victims of violent crimes.

### BACKGROUND OF THE INVENTION

The cellular phone device has become a very popular and indispensable tool for people all over the world. Its portability provides the most convenient two-way voice communication for people to have phone conversation in different locations. If any emergency occurs, such as kidnapping or abduction, the victim can dial 911 for help very easily with a cellular phone in hand. However, in many large cities there are still many women and young children missing without a trace each year. Those people usually are the victims of the violent crimes of murder, kidnapping, or sex offender abduction. Some of the adult victims may have carried a cellular phone with them while the violent crimes occurred, but for some unknown reasons they did not dial 911 for help when their lives were in danger.

It is not hard to imagine that when kidnappers, abductors, or sex offenders commit a crime, they typically want to take control over the victims in the shortest time possible and thereby prevent the victims from using a cellular phone to dial 911 for help. Furthermore, it is not easy for the victims to describe the emergency situation and the location of the crime to a 911 rescue team in just a few seconds on the phone. It would be most difficult for children who don't know how to use a cellular phone to call for help in such a desperate situation. Therefore, a need exists for an affordable wireless communication device that is easier and faster to use in an emergency situation, one that might even deter an attack in the first place.

The concept of transmitting audio and video messages via e-mail has already been applied in video e-mail products such as “SeeMail” by RealMedia Inc. and “VideoLink Mail” by Smith Micro Software Inc. This concept has also been disclosed in several U.S. patents such as U.S. Pat. No. 6,072,861 issued to Yu that relates to a device transmitting audio and image information remotely via e-mail; U.S. Pat. No. 6,085,231 issued to Agraharam, et al. which relates to a method and system for delivering a voice message via an alias e-mail address; U.S. Pat. No. 6,252,588 issued to Dawson that relates to a method and apparatus for providing an audio visual e-mail system; U.S. Pat. No. 6,389,276 which relates to systems and methods for providing voice mail notification from a separate voice mail system to a mobile telephone; and U.S. Pat. No. 6,564,248 that describes an e-mail system with a video e-mail player. Other related patents found during a routine search include U.S. Pat. No. 6,697,458 that discloses a system and method for synchronizing voice mailbox with e-mail box; U.S. Pat. No. 6,748,421 which describes a method and system for conveying video messages; U.S. Pat. No. 6,775,359 that relates to voice reply to incoming e-mail messages via e-mail; and U.S. Pat. No. 6,826,407 which relates to a system and method for integrating audio and visual messaging.

However, to our knowledge, the prior art does not include a means to send both voice and image messages in an e-mail format to a 911 center within a few seconds which would be valuable in making life-saving emergency calls. None of the aforementioned patents is believed to teach the key features of the claimed invention.

Although the existing 911 call system provides for the necessary response in many situations, particularly those where an accident or crime has already occurred, a faster way of communication that includes photo images of the attacker would be more valuable in certain situations such as in the seconds during a threat period before a crime or dangerous situation fully develops.

### SUMMARY OF THE INVENTION

The following three codes, PSU, PSS, and SOS button, have been referenced throughout the entire document in the descriptions of the structure and application of several new devices provided by the present invention.

PSU—The Portable Surveillance Unit, i.e. the voice and image e-mail transmitter device. The regular cellular phone which is upgraded to have the portable surveillance capability provided by the PSU component is also called the PSU phone.

PSS—The Portable Surveillance System, i.e. the system and method for processing the data produced by the PSU device. It is also called the PSU wireless communication system.

SOS button—A single push button located at the side of the PSU device. The top surface of the push button is in a slightly curved shape. When it is pressed the PSU will record the voice and image information, and when it is released the message digital signal string will be transmitted out. In the emergency use mode, the push button is dedicated to be used for sending PSU emergency calls only. In the private use mode, the center position and the two end positions of the push button may perform the private call function and emergency call function, respectively.

The present invention, hereafter referred to as the voice and image e-mail transmitter device, or referred to as the PSU device for short, contains hardware that can convert the human voice and image data inputted from an external camera and external microphone into digital signal string format in a split second, and it is a device that can transmit a digital signal string to a local voice-image message receiving station where the digital signal string is parsed and converted into voice and image message files by a new software program installed at the central process server of the voice-image message receiving station. Then this software program will create an e-mail to attach the digital signal string converted message files and delivers it to the user pre-defined destination e-mail addresses over the internet.

The PSU device comprises five major internal hardware components. The first component is the central process unit (CPU) which contains integrated microprocessors that converts the input voice and image data from analog format into digital format. The second component is a plurality of the internal memory chips. The PSU device has two types of internal memory chips which can store the input text data, the converted input voice and image data in digital format, and output digital signal string data. The third component is the GPS chipset which is primarily to be used to generate the location code of the PSU device when a message is transmitted out from this device. The fourth component is the clock which can generate the time code to show when the message is being sent. The fifth component is the battery, which is an essential hardware part to this device since it can provide the power source.

The receiving party of the digital signal string transmitted from the PSU device is the local voice-image message receiving station, which is actually the same base station that receives the digital signal sent from the cellular phone transceiver towers. The new software program installed at the central process server of each local voice-image message receiving station is constantly available to accept incoming digital signal messages sent from the PSU devices that are relayed via cellular phone transceiver towers.

The system and method of the wireless communication system for processing the digital signal data generated from the PSU device using the new software program is also called the PSU wireless communication system, i.e. the PSS system. The new software program of this system is responsible to parse out the voice and image messages from the digital signal string and generate the voice and image message files in a format such as the “.wav” and “.jpeg” files in just a split second. In one embodiment the size of the memory chips of the PSU device can be made large enough such that the digital signal string can be converted into a video message file, such as the “.mpg”, or “.avi” files instead of the separated voice and image message files. This new software program is also programmed to create an e-mail, which is called the PSU e-mail, to associate with each received digital signal string, and it will attach the voice, image, and/or video message files to the newly created e-mail and delivers the e-mail to the pre-defined destination e-mail addresses.

When the PSU device is initially used, the user needs to pre-register personal information such as the user name, gender, date of birth, home address, home phone number, primary e-mail address, type of spoken language, and user's most recent face photo picture, etc. on a “Registration screen panel” of the PSU device. Whenever a digital signal string is transmitted out from the PSU device it will include these personal information data plus a time code of the message being sent, the PSU device unique serial number, and the GPS generated location code, etc. which will all be imbedded in the PSU e-mail.

Note that the GPS generated location code imbedded in the PSU e-mail contains a pair of Latitude and Longitude codes in Barcode format which is a pair of numbers that describes the location on or above the earth. The format of the GPS generated coordinate code to be used in PSU wireless communication system will adapt the coordinate system used by various “Auto GPS Navigator” devices, such as the Garmin's GPS coordinate code of “N 38 deg 51.333 min W 094 deg 47.941 min”, or a pair of its converted decimal latitude and longitude numbers, in Barcode format. The decimal numbers in Barcode format can be easily read in by a scanning reader equipped in a new “GPS Tracking Machine” device which is a new device disclosed in the present invention.

When the PSU device is initially used, for security reasons the user also needs to type in the answers of the security questions, such as mother's maiden name, father's middle name, and the city where he or she was born. In addition, the user also needs to type in the “Registration update passcode” and the “GPS tracking passcode” on the “Registration screen panel” of the PSU device.

The digital signal string to be sent out from the PSU device may be constructed within the PSU device by the CPU microprocessors in several different formats. One of the preferred formats is the popular XML dialect tags format. The transmitted digital signal string with the data code separated by various XML tags can be easily parsed by the new software program that is installed at the central process server of the local voice-image message receiving station. Additional code data such as the time code of the message being received at the voice-image message receiving station, and the receiving station code will also be imbedded in the PSU e-mail for GPS tracking purposes.

In one embodiment, the voice-image message receiving station code, which is a code assigned by the PSU wireless communication system, may be a digital string containing 9 or 10 digits. The voice-image message receiving station code in United States, for example, may contain a three-digit country code followed by a two-digit state code, and followed by the remaining digits that represents a unique serial number of that station. The receiving station code imbedded in the PSU e-mail will be used for assisting the PSU wireless communication system and the law enforcement agencies to identify where an emergency call was originally received and delivered For the emergency calls, the new software program will translate the GPS generated location code into a 2-D location map file and attach it to the newly created PSU e-mail together with the voice and image message files in order to provide much clearer forensic evidence of the crime and show the location of the original crime scene on a map.

The purpose of the PSU device is to provide the average citizens and young children with an extremely simple and affordable tool for emergency and surveillance use. It is a self-defense tool that can help many people enjoy a safer and peaceful life and alleviate the fear of violent crimes. The PSU device may also be a valuable tool for national security and national defense purposes because citizens may use the PSU device to capture the photo images and provide evidence of suspected domestic terrorist activities if they happen to be the eyewitness. It may be used as a voice communication tool to supplement the regular phone voice message mailbox. The PSU device is a tool that can also be used by the managers to broadcast the urgent voice or video messages to many employees in the business offices. The photo transmit capability of the PSU device may also be attractive as a recreational tool. Tourists could take an unlimited number of pictures of scenery just as they would with a regular digital camera. Moreover, the modified version of the PSU device having a highly sensitive camera component may enable some law enforcement officials to employ the PSU device for investigative purposes. Since the PSU device has portable surveillance capability, it not only can be used to protect the users of this device, but also can be used to protect other people who are walking or standing nearby when an emergency occurs. For example, a lady jogger who is running in a park alone or a tourist who is standing on the deck of a cruise ship alone and suddenly attacked by someone, who might be a sex offender or a robber, may quickly grab the PSU device to take a photo image of the attacker and send an emergency call to a local police station or a 911 center with enough forensic evidence so that the incidents would not become the mysterious unsolvable cold criminal cases if the victims are murdered and disappeared without a trace. On the other hand, if a person is an eyewitness of a crime or an accident, then he or she may use the PSU device to quickly send an emergency PSU e-mail to a local police station or a 911 center to provide assistance to solve the criminal case. Most of the time it may be able to save the victim's life more efficiently than a regular 911 phone call because the PSU e-mail may provide the evidence and clues with the location information to assist the law enforcement agencies to capture the suspect much easier and faster. In the past, many unsolved criminal cases were due to lack of evidence and clues, but with the PSU device such kind of problems can be resolved.

The PSU device is preferably small enough to fit in a pocket and light enough to be attached to clothing, and has features that are easily accessible so that even a school age child can use it. In the exemplary embodiment, the PSU device is comprised of a keypad on the base portion and a viewing screen on the top cover portion. The base and cover may be permanently attached at one end along a rotatable hinge and may have a second attachment in the form of a clasp at an opposite end. The PSU device also has one or more sides that enclose the base and cover portions. There is also a SOS push button on a side of the base that may be pushed in toward the base to record a message and released to send a message. An external camera and an external microphone may be connected to a port on another side of the base of the transmitter device either by a wire or wirelessly.

Usually a PSU user prefers to define the e-mail address of family members, such as the parents, as the primary PSU e-mail receiver whenever an emergency occurs. By default, the closest police station, a dedicated 911 center, a hospital or health care center, or a participating volunteer or professional emergency responder will also receive a copy of the PSU e-mail to respond for the emergency call. If the victim is forced to relocate after placing an emergency call and the GPS generated code translated location map file attached in the PSU e-mail cannot be referenced to find the victim for a rescue, then a new GPS based people tracking system which applies the new “GPS Tracking Machine” device can be employed to find the most current location of the victim. This new “GPS Tracking Machine” is upgraded from the existing “Auto GPS Navigator” device. It is a very important new device disclosed in the present invention that can be used by the family members and law enforcement agencies to find the most current location of a victim while driving a car if the victim is forced by the suspect to relocate and is kept on moving. More information about the “GPS Tracking Machine” device will be described later in the detailed description section.

A wireless communication system that includes the PSU device cannot totally replace the existing 911 system. It must coexist with 911 system and only be used as a supplemental system for a 911 call. People who are in extremely dangerous situations that do not allow them to have enough time to connect to a 911 center with a home phone or a cellular phone would benefit the most by relying upon the PSU device for emergencies. The PSU device is the most effective tool for personal self-defense because once the photo picture and the criminal action of a suspect is taken by a hidden camera of the victim's PSU device and transmitted to a local 911 center within just few seconds, there is no way for the suspect to grab the picture from the victim and destroy the evidence of the crime.

Suppose a victim is murdered, kidnapped, or abducted and he or she disappears without a trace, then the PSU device may offer assistance by providing the most significant part of forensic evidence of the crime. As a result, the criminal who committed a violent crime will no longer be able to avoid prosecution and repeatedly to commit more crimes so easily, and the justice can be served. Furthermore, a lot of resources such as the time and money spent on searching for the victims and spent on crime investigations can be saved each year due to the new GPS based people tracking system provided in the present invention can assist the 911 rescue team to find the victim's most current location very efficiently, and the e-mail files generated by the PSU wireless communication system can provide enough evidence to help the law enforcement agencies to solve the criminal cases much easier and faster.

### BRIEF DESCRIPTION OF THE DRAWINGS

FIG. 1A is a diagram of the voice and image e-mail transmitter device, which contains a keypad with various key buttons, a viewing screen, a SOS push button, and the wire.

FIG. 1B is an enlarged view of the key button pad as shown in FIG. 1A.

FIG. 1C is an alternative representation of the four directions scroll key buttons B, C, D, and E as shown in FIG. 1B.

FIG. 1D is an enlarged view of the SOS push button as shown in FIG. 1A.

FIG. 2A depicts an external microphone with a chain and decoration to be used as necklace and it may be connected to the PSU device either by a wire or wirelessly.

FIG. 2B depicts an external microphone that has a button shape and a wire that may be connected to the PSU device.

FIG. 3A is an oblique view of a small external camera device which can be attached to a shoulder of the user and it may be connected to the PSU device either by a wire or wirelessly.

FIG. 3B is a top-down view of the small external camera device which may be attached to an arm of the user and which is connected to the PSU device either by a wire or wirelessly.

FIG. 4 depicts a handheld device which contains a handle bar, a pinhole camera, an external microphone, and a large push button. This diagram also includes a base holder that allows this device to be put on it to be used as an external webcam with external microphone for a PC or Mac.

FIG. 5A is a diagram of the “Registration screen panel” which allows the user to pre-register personal information and two passcodes for Registration panel update and GPS tracking functions. The user may also input the device serial number of a secondary PSU device on the panel to assist the GPS tracking for an extra cautious protection.

FIG. 5B is a diagram of the “Verification screen panel” which verifies the user's passcode for the authorization to update personal information in the “Registration screen panel”. It also contains a section for the police station to send a notify e-mail to a person who lost the PSU device.

### DETAILED DESCRIPTION OF THE INVENTION

The present invention relates to a voice and image e-mail transmitter device, i.e. the PSU device that has the voice and image digital signal transmission capability, and also relates to a system and method of converting the digital signal string into an e-mail format. By using the function of the input digital signal data conversion hardware built inside of the PSU device instead of relying solely upon the conventional software such as the operating system in the Smartphone, the reliability and the speed of converting and transmitting digital signal messages can be greatly improved.

After I disclosed the portable surveillance function using the PSU device with the descriptions of a wireless communication system and method for the implementation of such function in U.S. Pat. No. 7,751,534, I was motivated to further improve this transmitter device to enable improved and faster GPS tracking of the victim's location for rescue purposes. The reason why such improvement is very important is because in many situations when a violent crime occurs and after the victim places a PSU emergency call, he or she may be forced by the attacker to move to another location which could be very far away from the original crime scene. By checking the GPS generated code translated location map which is attached in the PSU e-mail, the law enforcement agencies may only be able to find the location of the original crime scene but not the new location of the victim. However, by using the improved GPS based people tracking system according to the present invention which applies a new PSU phone number dialing system by using the PSU device serial number as the phone number, then the most current location of the missing victim can be found and the victim's life can be saved. More detailed information about the new GPS based people tracking function and the new PSU phone number dialing system will be described later in this section.

The PSU device is very similar to a regular cellular phone, but it is not a cellular phone device. The PSU device digital signal string to be transmitted out is usually bundled in a packet which is named PSU signal packet that has its own System Identification Code (SID) which will be assigned by the FCC in the future. The SID in the PSU signal packet is different from all the SID in various types of regular cellular phone packets and will not be recognized and accepted by any service providers in the future unless a future law will be legislated. The PSU signal packet of an emergency call contains not only the voice and image digital signal message data but also the caller's personal information data for the GPS tracking purpose. It is a small packet which is created from the message recording process in a PSU device during a very short period of time in an emergency situation, and it contains a minimum amount of voice and image message data that is necessary for the emergency call to a local 911 center only. Since it is an alternative format of the emergency calls, a future law may be required to request for an agreement from all the service providers to accept the PSU signal packet SID and allow the digital signal string to be passed through their wireless network lines to a local base station free of charge because it would not cost the service providers too much resource to transmit it to a base station that is not far away.

Note that the free service offer only applies to the PSU emergency calls. The PSU user will still need to pay a monthly phone service fee for the private PSU calls because the digital signal packet of the PSU private calls might be very large which would cost the service providers a lot of resources to transmit it to a base station that might be very far away. In the future the PSU users who need to use this device for private phone calls in United States are required to register for the phone services from a service provider the same way as the regular cellular phones. There is a single bit code that is imbedded in the PSU digital signal string which can be decoded by the new software program to indicate whether the PSU digital signal string is for emergency use or for private use. This bit code is setup based on the usage mode setting of a key button on the PSU device and the final finger position on the SOS push button. More information about this key button will be described later in this section.

With the assistance from service provider as required by a future law, when the digital signal string is transmitted from the PSU device, the signal packet will be initially transmitted to the nearest cellular phone transceiver tower first, and then it will be relayed to a local voice-image message receiving station which is the same base station for processing cellular phone signals. After that, the PSU signal packet will pass through the landline and is then transmitted from base station to a local processing server center. From there the digital signal string in the PSU signal packet will be parsed and decoded, and it will be routed to the new software program of the PSU wireless communication system to create a new PSU e-mail associated with the digital signal string instead of routing to the existing software program of the phone communication system for the cellular phone number dialing process.

Frequently, the “Signal out of Range” problem occurs to some types of regular cellular phones when a phone call is made in certain regions of United States because none of the local service providers would provide service to the digital signal packets sent from those cellular phones which have the SIDs that belong to other service providers. It is really a big problem that always bothers many cellular phone users because the cellular phones they own do not work at some locations in United States while they are travelling. Such a problem should never be allowed to occur with the PSU emergency calls because the majority of those calls may be life and death related critical emergencies that should not be rejected for delivery by any service providers. Therefore, it is really necessary for the U.S. Government to support this new law in the future to request all service providers in United States to sign up an agreement to always deliver the PSU emergency calls very promptly with free services. Note that this future new law might only be required in U.S. because the service providers in United States are not united and each company may determine its own regulations for the service charges since United States is a free enterprise country. This future new law may not be necessary for many other countries if the PSU wireless communication system will also be built up in those countries in the future.

To measure the serviceability of the service providers, both of the software programs of the service providers and of the PSU wireless communication system will have a counter implemented therein which may be used for counting the total of the free service for the PSU emergency calls and these two totals should match each year.

Other than supporting the future law to set some rules to the service providers for the free services, the U.S. Government will also need to deal with some issues in the future about how to compensate the service providers for their free services to the PSU emergency calls. For instance, the U.S. Government may consider offering them tax credits based on the total free services they have provided in a year. In other words, each PSU emergency call a citizen has placed will not be totally free but it will be paid by the tax money since protecting the citizen's lives is actually a part of U.S. Government's responsibility.

The PSU device primarily contains three models, which are the basic model, advanced model, and simplified model. The basic model PSU device does not have a speaker, thus it is not a cellular phone. It can be used by a PSU owner to place an emergency call in the PSU e-mail format, in which it contains the voice and image message files, and send to a closest local police station or a dedicated 911 center in a one-way voice and image e-mail communication fashion. Since the basic model PSU device is not a cellular phone, thus it does not need to have a regular phone number. It is a low-cost device that is most suitable for young children to use because they do not need to pay a monthly phone service fee to use such PSU device only for emergency calls.

The basic model PSU device not only can be used for the emergency calls and for the new GPS based people tracking functions, but also can be used for private use in many business offices. For example, a PSU user may use this device to broadcast a voice or video message to many e-mail accounts and many phone recipients simultaneously either in a PSU e-mail format or a voice mail format. It is an alternative way for a business manager to send an important or urgent message to many employees, and it is a much easier and faster way than the conventional text e-mail mass mailing method because typing sentences in an e-mail needs to take longer time than making a voice or video message. Furthermore, in the psychological point of view, voice or video messages are always more impressive and much easier to be accepted and remembered by many people than text messages.

The basic model PSU device may be added to various types of regular cellular phones, which includes the Smartphone, and it can share several common hardware components with them such as the CPU, memory chips, GPS chipset, battery, antenna, keypad, viewing screen, camera, and microphone, etc. so that the PSU device may also have the two-way voice communication capability just like a regular cellular phone. The modified version of the PSU device is called the advanced model of the PSU device, or called the “PSU phone”, which is also the so-called “next generation cellular phone”. As a result, all regular cellular phones can be equipped with the portable surveillance function, and they may also have the GPS based people tracking function for protecting people's lives as well as the voice or video message broadcasting capabilities for the business office applications in the future if they are upgraded from the basic model to the advanced model. There is a switch (not shown) on the advanced model PSU device that can be used to toggle the PSU device between the cellular phone mode for the phone conversation and the portable surveillance mode for sending the PSU emergency calls.

The simplified model PSU device does not contain the components of speaker, camera, microphone, and SOS push button, but comprises the components of CPU, memory chips, keypad, viewing screen, antenna, GPS chipset, and battery that are required only for the GPS tracking function for the valuable assets such as cars, boats, safety boxes, and cargo, etc. It is a tiny GPS tracking device which does not have the portable surveillance capability, and some people may also use it for tracking the location of missing toddlers or search for wandering small children because it is a relatively inexpensive and non-sophisticated device that does not need a very young child to press any key buttons on the device. The full GPS tracking capability of the simplified model PSU device makes it qualified to be the secondary PSU device for some users. More information about this extra protection and the secondary PSU device will be described later in this section.

The following is a detailed description of the structure and the application of the basic model PSU device which provides the portable surveillance function that can be used to protect many people and save their lives.

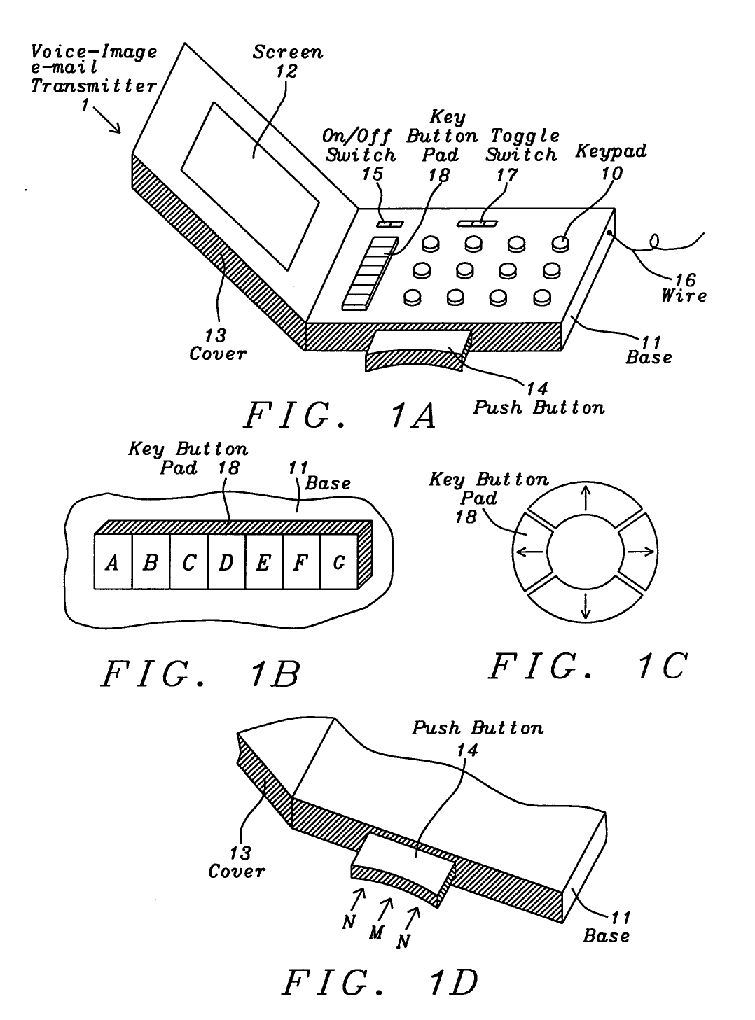

Referring to FIG. 1A, the PSU device according to the present invention looks very similar in certain ways to a regular cellular phone, and it comprises five major internal hardware components that are not shown because they can be arranged in various designs that depend upon the manufacturer. The first component of the PSU device is the central process unit (CPU) that comprises an A/D converter microprocessor to perform the function that converts the input voice and image data from analog format into digital format. For handling the input photo image data, the CPU contains an image processing encoder microprocessor. The CPU also comprises a microprocessor that stores the converted input digital data into memory chips and then combines the converted digital data from memory and constructs an output digital signal string with imbedded Extensible Markup Language (XML) dialect tags. The second component is a plurality of internal memory chips. There are two types of memory chips, i.e. the static and the dynamic memory chips, which may be used for storing the text data of the user pre-registered personal information, the converted input digital voice and image data, and the newly constructed output digital signal string that consists of both input text data and the digital voice and image message data. The third component is the GPS chipset which can be used to generate a geographic location code when the user sends out a message. This GPS generated code can be translated into a location map by the new software program to show the physical location of the caller if he or she uses the SOS push button to place an emergency call. The fourth component is an internal clock that can generates a time code to indicate when the message is sent. The date and time of the clock can be synchronized with the system clock implemented at the PSU central communication server automatically whenever the PSU device is powered on or a special “Clock” button is pressed. The fifth component is a suitable battery. Since the PSU device is to be used to perform a very critical life-saving function, a high quality and durable battery that can last for a very long time without the need to be frequently recharged is preferred. Since the battery power source is very crucial to the PSU device, therefore in one preferred embodiment the PSU device may be designed to have a small and low cost solar battery, which is powered by day light, to be implemented as a backup in case the regular battery is drained because the PSU user forgets to recharge it. When the regular battery power level is low, a tiny red warning light which is located at the corner on the cover of the PSU device should be lit.

Other than the five major internal hardware parts, there are few external hardware components such as a keypad, a viewing screen, an antenna, an external camera and external microphone that are connected to the base portion of a PSU device either by a wired or wirelessly, and a SOS push button, which are also the required parts of the PSU device.

In FIG. 1A, the keypad panel 10 on the PSU device allows the user to type in the text data such as the user name, gender, date of birth, home address, home phone number, the primary e-mail addresses, and most recent face photo picture, etc. in the pre-registration phase, and it is located on the top surface of a base portion 11. Note that data entry should be performed while setting up the device during the pre-registration phase on a “Registration screen panel” and not during the potentially dangerous situations where fast communication is essential. In one design, the keypad 10 may contain numerical and alphabetical key buttons plus a few other keys such as the at-sign “@”, plus-sign “+”, comma, and dot key “.”, etc. similar to a regular computer keyboard. The keypad may be designed as a touch screen panel instead of a board panel format. In case the PSU device will be used internationally, then the layout of the keypad for each country may be different. Thus, each keypad of the PSU device may be designed based on the country code of the device serial number since a different character set will be used in different countries. More information about the country code in the PSU device serial number will be described later in this section.

In one embodiment, the base portion 11 is substantially rectangular in shape and has a certain thickness and a top surface on which the keypad 10 is located. There are four sides surrounding the base portion. A cover portion 13 is also substantially rectangular in shape and may be affixed to the base portion at one end on a hinge. At the opposite end, the top cover portion 13 may have a clasp that attaches to the base portion 11 to close the device. There may also be an antenna (not shown) connected to or imbedded in the base portion 11 that is employed for transmitting digital signals from the PSU device.

The cover portion 13 is comprised of a viewing screen 12 that can be viewed at the same time as the keypad 10. The input text data such as the phone numbers and e-mail addresses, etc. which is entered from the keypad 10 by the user will be saved in the internal memory and may display on the screen 12 for verification or modification. The advanced model PSU device may have a user registered regular phone number from a phone company which allows the user to have a phone conversation with other phone users or receive phone voice messages sent from other persons. If the PSU device is employed as a regular cellular phone, then many phone numbers may also be entered from the keypad 10. In one embodiment, a built-in microphone (not shown) in the base portion 11 and a phone speaker (not shown) in the top portion 13 may be incorporated in the PSU device the same as in a regular cellular phone. Thus, the PSU device may have regular cellular phone capability if it is upgraded from the basic model to the advanced model. The design of the advanced model PSU device may vary and it is based on the design of each type of regular cellular phone which is beyond the scope of the present invention and will not be described herein.

A key feature of the basic model of the PSU device is a SOS push button 14 that is disposed on a first side of the base portion 11. This SOS push button 14 may be pressed in toward the base portion 11 to record a message and released to send the message. A wire 16 may be used to connect an external camera and external microphone to the PSU device through a port in the base portion 11. In one embodiment, the wire 16 is affixed to a port on a second side of the base portion 11. Optionally, if the PSU device provides wireless connection to the external camera and external microphone, then the connection wire and the port will not be necessary.

The PSU device may be attached to a belt at the waist, put in a purse, or in a pocket of a piece of clothing such as a shirt or pants from where the user may easily grab this device when he or she needs it. A pendant or a watch (not shown) can be wirelessly connected to the base portion 11 of this device as a supplement of SOS push button 14 which allows the users, especially the senior citizens, to place an emergency call much faster and easier. More information about the pendant or watch feature will be described later in this section.

The screen 12 is divided into many grids to allow users to enter input data. Each e-mail address and phone number entered into a grid from the input keypad 10 is known as an item. A plurality of items may be formed as a list and stored in the internal memory chip (not shown) within the base portion 11. A key button pad 18 may be located on the surface of the base portion 11 adjacent to the keypad 10, and in the exemplary embodiment it contains seven small key buttons labeled A-G as shown in FIG. 1B.

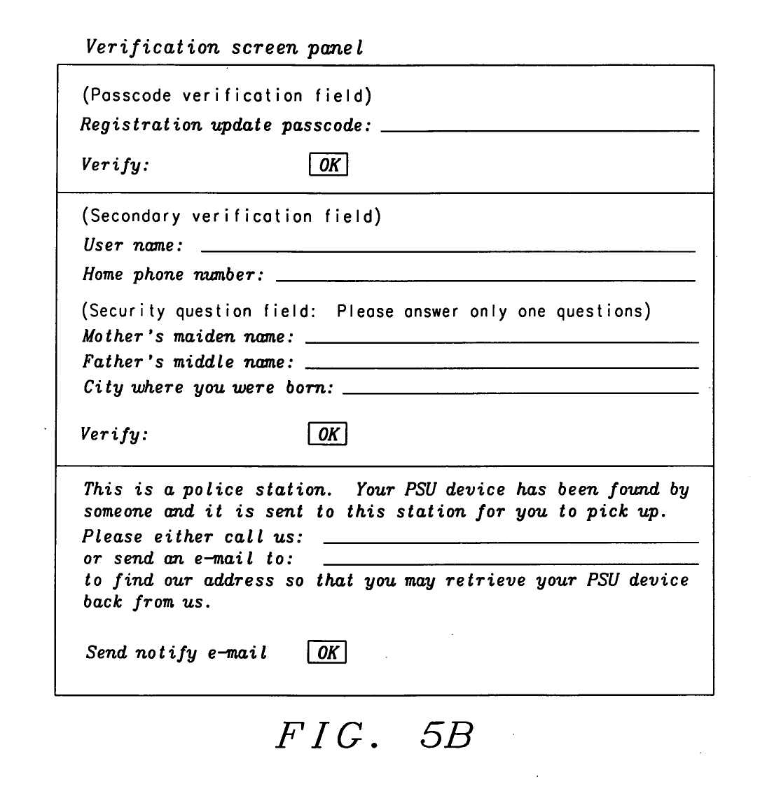

The key button A may be employed by the user to pre-register personal information. When the PSU device is initially setup, the user may place the cursor at any location on the screen 12 and press the key button A to display the “Registration screen panel” (as shown in FIG. 5A) from where the user may input data such as the user name, gender, date of birth, home address, home phone number, primary e-mail address, and the type of spoken language, etc. The PSU user may use the external camera to take his or her own most recent face photo picture and store it in the PSU device for the GPS tracking purpose. To take such a photo picture, the user needs to move the cursor on the face icon at the “Face photo picture” option in the “Registration screen panel” and press the key button A while the external camera is pointing to his or her face. If face photo picture has already been taken before, then a new photo picture will replace the existing one.

For verifying the authorization to update the “Registration screen panel” purpose, all users must fill in one of the answers in the security question field such as mother's maiden name, father's middle name, or the city where he or she was born if the passcode is not answered. The PSU user must fill in a “Registration update passcode” on the panel in order to be able to obtain the authority to update the personal information in the future, and also needs to fill in a “GPS tracking passcode” in order to allow someone, such as family members or friends, to be able to obtain the authority to track the location of the PSU device that is carried with him or her. For the extra cautious user who always carries two PSU devices for protection, there is an optional field named “Secondary PSU serial number” on the “Registration screen panel” for the user to write down the second PSU device serial number on the PSU device. Note that there is no “Secondary PSU serial number” field on the “Registration screen panel” of the simplified model PSU device because it is not equipped with the portable surveillance capability. More information about the “Secondary PSU serial number” option on the basic and advanced model PSU device will be described later in this section.

In case the PSU device is lost or stolen, the confidentiality of the user's pre-defined personal information stored in the PSU device can be well protected by the “Registration update passcode”. Therefore, for the GPS tracking purpose the user must fill a real name instead of a nickname in the user name field on the panel. The date of birth field is a required field for all users and it must not be left blank. It is very important for a young PSU user to fill the correct data in the date of birth field because the law enforcement agencies are always very concerned about the safety of the young and defenseless victims when an emergency or accident occurs to them. The home phone number field is also required which cannot be left blank because this information can be used by the law enforcement agencies to contact with a victim's family member when it is necessary. The home address field is optional and it can be left blank.

The owner of the primary e-mail account usually will receive a copy of the PSU emergency e-mail when an emergency occurs. Therefore, the young PSU user must fill one of the parents' e-mail addresses in the primary e-mail address field because the parents will need to receive a copy the PSU emergency e-mail when an emergency occurs to their child. If a PSU user and his or her parents and all other family members do not have a PC or Mac and none of them or any friend has subscribed to an e-mail account, then the primary e-mail address field may be left blank. Usually, the PSU user may select any e-mail address of an owner who may be a parent, a family member, or a friend to be specified in the primary e-mail address field to receive a copy of the PSU emergency e-mail when an emergency occurs to him or her. Two e-mail addresses separated by a comma or a blank space may be filled in the primary e-mail field.

The type of spoken language field is optional for most users and can be left blank. However, the user may fill several language types in this field as desired. This is a rather important field for some users if the language they speak, which will be recorded in the voice message file attached to the PSU e-mail, is not easy to be understood by the local law enforcement officials while the person is travelling in a foreign country. In that case, the local law enforcement officials will need to check the information in this field in order to use some appropriate “Speech Interpretation” or “Voice Recognition” software, or hire a language translator who can understand the spoken language to solve the problem. For the missing people tracking and the PSU device ownership verification purposes, the users are highly recommended to use the external camera to take a face photo picture and save it in the PSU device although it is an optional field. For the security reason, all users must fill in all three answers in the security question field, which include mother's maiden name, father's middle name, and the city where he or she was born. The “Registration update passcode” field is mandatory and it must be filled with a code string from four to seven characters, digits, or mixed with characters and digits. This passcode allows the user to obtain the authority to open the “Registration screen panel” and update the personal information in the future when it is needed. The “GPS tracking passcode” field is also required, which must be filled in with a four-digit pin number. It is to be used for preventing an unauthorized person from tracking the physical location of the PSU user without permission. These two passcodes are the user specified arbitrary keywords which are unrelated codes and they may or may not be identical. To keep the PSU device very secure, it is highly recommended that the PSU user may update these two passcodes periodically if necessary. After updating the “GPS tracking passcode” on the PSU device, the PSU user should not forget to inform the family members or friends about such updates so that they can change the passcode recorded on the “GPS tracking item” on their PSU devices.

Finally, there is a special field called “Secondary PSU serial number” on the panel which allows the PSU user to fill in the second PSU device serial number if the user always carries two PSU devices for his or her protection. This field is optional, and it can help the police to search for the missing PSU user if the primary PSU device is not with the user for some reasons after the PSU user placing an emergency call using the primary PSU device. More detailed information about the secondary PSU device function will be described later in this section.

For security purposes, all the text data filled in the input fields on the “Registration screen panel” is case-sensitive. When the pre-registration process is completed, the user may move the cursor on the OK icon at the “Save and Exit” option on the panel and press the key button A again to save the pre-registered personal information data in the PSU device and close the “Registration screen panel”.

Whenever a digital signal string is transmitted from the PSU device, the user name, gender, date of birth, home address, home phone number, primary e-mail address, type of spoken language, and the face photo picture of the aforementioned personal information plus a time code of the message being sent, the PSU device unique serial number, and the GPS generated location code, etc. will all be included in the digital signal string and imbedded in the PSU e-mail. For GPS tracking purposes, the GPS generated location code will appear in the PSU e-mail in a pair of regular decimal number format. The information of the GPS generated location code, the PSU device serial number, and the PSU user's date of birth will also appear together in Barcode format on a separate code line. If the user previously specified a serial number of the secondary PSU device on the “Registration screen panel”, then the information of the secondary PSU device serial number and the user's date of birth will also appear in Barcode format on another code line. The Barcode printed on the PSU e-mail can be read in by a scanning reader of the “GPS Tracking Machine” device for law enforcement agencies to track the most current location of a PSU user.

The pre-registered personal information in the PSU device can be updated by any person as long as a correct “Registration update passcode”, which matches the previously specified passcode, is entered from the “Verification screen panel”. Therefore, a PSU user can transfer the ownership of his or her PSU device to another person, who may be a family member or a friend, simply by giving the PSU device to that person as a gift and telling him or her “Registration update passcode”. Of course that person also needs to change the ownership registration from a phone company if the PSU device has already been registered by the original owner as a regular cellular phone.

Whenever a user wants to update the personal information on the “Registration screen panel” of a PSU device, he or she may move the cursor at any location on the screen 12 and press the key button A first, then a “Verification screen panel” (as shown in FIG. 5B) instead of the “Registration screen panel” (as shown in FIG. 5A) will be displayed. On the “Verification screen panel” the user needs to enter the correct “Registration update passcode” in the top section of the panel and move the cursor on the OK icon at the “Verify” option, and then press the key button A again. The “Registration screen panel” will be opened to allow the user to update the personal information if the entered passcode matches the previously specified passcode. Otherwise, the “Verification screen panel” will close without making any changes.

If the user forgets the “Registration update passcode”, then the passcode field in the top section on the “Verification screen panel” may be left blank and start to input data in the middle section on the panel. In the middle section, there are three data fields which are the user name field, home phone number field, and security question field which contains the questions of mother's maiden name, father's middle name, or the city where the user was born. The user must enter all the data correctly in the first two fields and enter only one correct answer in the security question field, then move the cursor on the OK icon at the “Verify” option and press the key button A again. If all input data entered in the middle section matches the previously specified data, then the “Registration screen panel” will be opened to allow the user to update the personal information. Otherwise the “Verification screen panel” will close without making any changes. Note that only one of the three questions in the security question field is needed to be answered. If more than one answer is given by a user, then the correctness of all answers will be checked. It is recommended that each user needs to answer only one question in the security question field which is in the middle section on the “Verification screen panel”. There is no restriction on how many attempts a user may try to input the correct data on the “Verification screen panel” in order to open the “Registration screen panel”.

If a user forgets the “Registration update passcode” and is also unable to input the correct data in the middle section on the “Verification screen panel” to open the “Registration screen panel”, then it is quite possible that the PSU device does not belong to this person because he or she could not even remember own name, own home phone number, and one of the security questions such as own mother's maiden name, own father's middle name, or the city where he or she was born.

In this case, if the PSU user still has a purchase receipt which shows the retail store name, the purchase date, total price of the PSU device with tax, the serial number of the PSU device, and the name of the purchaser written on the receipt by the store owner, then he or she may send the PSU device with a photo copy of the receipt as a proof and pay a process fee to a specific manufacturer to reset the “Registration update passcode” on the PSU device. After the passcode is reset, the PSU user will be notified from a local police station to retrieve the PSU device. Meanwhile the police will open the “Registration screen panel” on that PSU device in front of the user to double check the previously registered data, especially to check the most recent face photo picture that has been formerly registered, to make sure that he or she is the real PSU owner.

Therefore, to avoid trouble associated with forgetting a “Registration update passcode”, it is highly recommended that when a PSU user updates the data on the “Registration screen panel”, he or she should always remember to jot down the new updated “Registration update passcode”, the new home phone number, or new answers to the security questions on a piece of paper or record it in a computer file. The PSU users may also consider entering all lower-case data in the input fields on the “Registration screen panel” since all the input text data are case-sensitive. The PSU users must remember to keep only a record of the most currently updated new passcode because once a passcode is updated the old one will become invalid automatically. They may also consider either updating the two passcodes less frequently or assigning two identical four-digit pin numbers to both passcodes all the time if they do not want to always remember two different passcodes for the authorization to update the “Registration screen panel” and for GPS tracking of the PSU device.

Most PSU users would like to inform their latest updated “GPS tracking passcode” only to family members or a few friends. Sometimes, if a person who knows your PSU device “GPS tracking passcode” has dialed your PSU device serial number as a phone number on his or her PSU device followed by a plus-sign “+” and your “GPS tracking passcode” to send a GPS tracking request to your PSU device, then your physical location can be tracked by that person who uses the new PSU phone number dialing system to track the location of your PSU device. The physical location of a PSU user can be protected by the new software program installed at the central process server from any unauthorized persons. When an unauthorized person tries to send GPS tracking requests with various invalid passcodes to your PSU device repeatedly more than 3 times in the same day, this new software program can detect the repeated unsuccessful attempts and it will block and ignore any more invalid GPS tracking requests sent from that person to your PSU device for certain length of time, such as a month, without responding with an error message. The temporary block will be removed automatically when this certain period of time is finished.

Usually each PSU device can accept two GPS tracking passcodes at the same time. One is the user defined passcode specified on the “Registration screen panel”, and the other is a special secret passcode generated by a new police “GPS Tracking Machine” device. The machine generated secret passcode is a four-digit pin number that is typically unknown to anybody including the PSU owner. The secret passcode can be generated by the police “GPS Tracking Machine” device based on a secret formula associated with the information of the PSU device serial number and the birth date pre-registered on the PSU device owned by a PSU user, which can be obtained from the Barcode printed on the PSU emergency e-mail sent from that PSU user. For privacy reasons, a police badge reader is equipped on the “GPS Tracking Machine” device such that only law enforcement officials are allowed to sign in to operate the machine and send the GPS tracking requests to track the location of a PSU user. Therefore, an ordinary citizen who does not have a police badge cannot use the police “GPS Tracking Machine” device to track any other person's location without permission. The police “GPS Tracking Machine” device that is upgraded from the existing regular “Auto GPS Navigator” is a very important new device for law enforcement agencies to track many missing persons. Without using the scanning reader to read in the Barcode from a PSU emergency e-mail, even the police do not have the authority to track the location of a missing person because the police “GPS Tracking Machine” device cannot generate a secret GPS tracking passcode without knowing a PSU device serial number and the birth date information specified on the missing person's PSU device unless the victim's PSU device serial number and its passcode information can be provided by a family member or friend.

It is highly recommended that a person should always remember to inform family members what is his or her PSU device serial number and the “GPS tracking passcode” he or she has specified before taking a long journey out of town so that the family members may use a PSU device to track the most current location of that person whenever they want such that they do not need to feel too much worried about their loved one who is travelling far away.

The parents may also use this device to track their children when they are wondering around and not coming home during normal hours. The PSU device can always be used to track the location of another PSU device quietly without catching the attention from the owner of that PSU device, and the PSU users usually do not know that their physical location has been tracked. Therefore, the parents may always keep a record of the children's PSU device serial numbers followed by a plus-sign “+” and the child's “GPS tracking passcode” as a “GPS tracking item” on the PSU device such that they may track the children's whereabouts very easily. More information about the “GPS tracking item” specified on the PSU device for tracking people's location will be described later in this section.

Usually if a PSU device was lost at home, an office, or a shopping mall, then it can be found by the PSU owner very easily simply by using another PSU device to send a GPS tracking request to locate the lost PSU device. However if a PSU device was lost on a train, a cruise ship, or some other place not so easily to be retrieved, and it was found by someone then the person who found the PSU device must submit it to a local police station immediately. Otherwise, the finder may be charged with stealing in case the lost PSU device is recovered from his or her possession by police because all PSU devices are traceable and nobody is allowed to take over any other person's PSU device, which contains pre-registered personal information of the original owner, without permission.

When a police station receives a lost PSU device, the police officer may press the key button A on the device to display the “Verification screen panel” (as shown in FIG. 5B), and type in a phone number or an e-mail address of the police station in the bottom “Lost and Found” section on the panel, and press the key button A again on the OK icon at the “Send notify e-mail” option to send a notify e-mail to inform the owner of the lost PSU device to retrieve it from the police station. The owner of the lost PSU device who receives the notify e-mail may contact the police station to find the address information, and then bring the ID card such as Social Security card or Driver License card to the police station to retrieve the lost PSU device. If the PSU owner discovers that the location of the police station is really too far away from home, then he or she may send an envelope with a check for full postage, the return address, a photo copy of the ID card as proof of ownership, and mail the package to the police station to retrieve the lost PSU device. To retrieve the lost PSU device from a police station by mail is not recommended because the PSU device might be lost again in the mail delivery.

If the owner of the lost PSU device discovers that the building at the address where the lost PSU device is supposed to be retrieved is actually not a police station, for personal safety reasons, the PSU owner should contact a police station and ask a police officer to help retrieve the lost PSU device. The finder of a lost PSU device should never open the “Verification screen panel” on the PSU device to send an e-mail to notify the PSU owner by himself. The person who lost the PSU device must be very careful and always examine the “notify e-mail” to be sure it is a genuine e-mail generated by a PSU device, in which it contains the user's formerly registered personal information. If the notify e-mail does not contain the trustworthy pre-registered personal information and it is not sent from a police station, then it may be a fake notify e-mail which could be very dangerous. In this case, the user must contact the police to capture the suspect who sent the fake notify e-mail.

If the finder previously robbed the victim and committed a violent crime, and is now trying to send a fake notifies e-mail to contact the victim's family, then it might be a good opportunity for the law enforcement agencies to capture the suspect. However, if the finder just found the lost PSU device by accident, then he or she should take the PSU device to a local police station immediately without worrying about being interrogated by police so that the owner can retrieve the lost PSU device very quickly. When a lost PSU device is brought to a police station, the police officer should ask the finder some personal questions such as the finder's name, age, profession, home phone number, the location and the date/time that the PSU device was found, etc. and keep a record for future investigations if necessary. With some useful information from recovered PSU devices, it might help the law enforcement agencies to find critical clues to solve some criminal cases.

Referring to the FIG. 1B, the key button B may be used to scroll the cursor from the displayed item list on the screen 12 in the forward direction, the key button C may be used to scroll the cursor from the displayed item list on the screen 12 in the backward direction, the key button D may be used to scroll the cursor on the item list line displayed on the screen 12 in the left direction, and the key button E may be used to scroll the cursor on the item list line displayed on the screen 12 in the right direction. In one embodiment, the four small key buttons B, C, D, and E may be put together in a round shape key pad as shown in FIG. 1C, for example, instead of the bar shape as shown in FIG. 1B. There are four pointers on top of the key buttons that point to four different directions as the indication of the function of these four key buttons. Note that the labels A-G on the key button pad 18 shown in the diagram are for an illustrative purpose only. The actual PSU products may have a different design with alternative labels for key buttons on the pad.

When a key on the keypad 10 is pressed at a cursor location on the screen 12, then the input data code, which may be either a number or a character, will be typed in and saved in the memory chips. These data may construct an e-mail address item or a phone number item and form an item list that will be displayed on the screen 12 for selection. After the item list is constructed, the user can move the cursor on the list and press the key button F to either select or de-select one or more e-mail addresses and/or phone numbers as the user pre-defined message recipients. Two other key buttons (not shown) on the key button pad 18 for the “Insert” and “Delete” functions may be needed. In one embodiment, the keypad 10 may be designed as a touch screen panel format which includes the key buttons from key button pad 18 in an arrangement similar to a computer keyboard instead of the keypad on a board format as shown in FIG. 1A.

In the item list there are two other special types of items other than the e-mail items and phone number items can be specified: One type is the item with a leading keyword “Group” followed by a group name or number and a colon-sign “:”, and followed by several e-mail addresses and/or phone numbers separated by commas. This special item is called the “group item”, and the e-mail addresses and/or the phone numbers can be mixed together in the “group item”. If the code line in a “group item” is longer than the screen line in a grid on the screen 12, then it can be wrapped around and extended to next line. The last item of the “group item” in the same grid will be ended without a comma.

The other type of the special item is a PSU device serial number followed by a plus-sign “+” and a “GPS tracking passcode”, which has already been mentioned before. This type of item is called “GPS tracking item” because it is a phone dialing number with a passcode which can apply the new PSU phone number dialing system to track the location of a PSU device.

By default, the basic model PSU device is set for emergency use mode. The seventh key button G on the key pad 18 can be used for the usage mode setting. When it is pressed it can set the PSU device to the private use mode. If the key button G is pressed again while the PSU device has already been set to private use mode, then the PSU device will reset back to the default emergency use mode. Thus, the key button G can be pressed multiple times to toggle the PSU settings between emergency use mode and private use mode. In one embodiment, the key button G may be designed in a two-way toggle switch format instead of a key button format. There is a single bit code imbedded in the output digital signal string which is based on the setting of the key button G and the final finger position on the SOS push button 14. When the digital signal string is parsed by the new software program which is installed at the central process server, this bit code will be decoded to determine if the digital signal string is for the emergency use or for private use.

When the PSU device is set to private use mode, several e-mail addresses and/or phone numbers can be selected at the same time by pressing the key button F on different items from the screen 12 a few times. By pressing the key button F on a “group item” from the screen 12, the user also can select several e-mail addresses and/or phone numbers at the same time. If few e-mail addresses are selected, then a voice or a video message e-mail will be sent to each selected e-mail addresses over the internet. If multiple phone numbers are selected, then a phone voice mail will be delivered to each of the selected phone recipients over the phone communication system. The items that have been selected will be displayed on the screen 12 in yellow color. The user may press the key button F to de-select the previously selected e-mail addresses and phone numbers after the message has been sent out, then the color of the de-selected items on the screen 12 will be reset to the original color which is other than the yellow color. In one embodiment, a “Reset” key button (not shown) may be designed to be added to the keypad 18, such that when it is pressed all previously selected items will automatically be de-selected.

In the private use mode, if a “group item” or multiple items are selected by the key button F simultaneously, then the PSU device can be used to broadcast a voice or video message in the voice mail or video message e-mail format to several e-mail accounts and many phone recipients at the same time. There is no problem for the PSU wireless communication system to provide such a powerful function because the new software program installed at the central process server can be programmed to recognize the difference of the e-mail address format and the phone number format selected from the item list such that it can deliver different format messages to various recipients accordingly. It is very similar to the e-mail editor program implemented in a PC or Mac which allows the user to specify multiple e-mail addresses to perform the text e-mail mass mailing function. When a video message is broadcast over phone communication system usually the phone recipients can only hear the voice message portion but cannot see the video images. As mentioned before, using the PSU device to deliver a voice or video message to a massive audience is usually much efficient than the conventional text e-mail mass mailing method because typing sentences in an e-mail takes longer time than making a voice or video message.

In one embodiment, a key button (not shown) may be designed to be added to the keypad 18, such that when it is pressed a “Subject screen panel” (not shown) will be displayed which allows the user to fill in an e-mail subject title. If nothing is entered in the “Subject screen panel”, then a program generated short phrase such as “Please referring to attached message files” will be automatically filled in the subject field in the PSU e-mail.

In another embodiment, an additional set of camera and microphone (not shown) other than the external camera and external microphone may be implemented on the PSU device and preferably located at the center of the top edge on the screen 12 if the PSU device is frequently used for broadcasting voice and video messages.

The “Subject screen panel” is designed to be used for the private use mode only. It should not be used for the emergency use mode because usually there is no time for a PSU user to open the “Subject screen panel” to fill in a subject title when an emergency occurs. The subject field of all PSU emergency e-mails will always be filled with a program generated short phrase such as “Emergency Call” as default. In the subject field it also contains the caller's name, a voice-image message receiving station code, and a timestamp of the date and time that the message was sent from the caller and received by the voice-image message receiving station, which will be suffixed to the short phrase of “Emergency Call” for the identification of the emergency e-mail purpose.

The concept of the aforementioned voice or video e-mail message broadcasting function on the PSU device can be applied to the software system in a PC or Mac. In one preferred embodiment, a personal computer user may click a program icon on the Windows startup screen to display a voice or video message e-mail process panel, which is similar to the text e-mail editor implemented on most PCs or Macs, and he or she may select a group of e-mail addresses and/or multiple phone numbers from this panel, and then fill a short phrase in the subject field. By using the PSU device, the user may only make a short voice or video message for broadcasting each time due to the limited size of the PSU memory, but with the large memory size in personal computer it would allow the user to make longer video speeches for broadcasting. On the PC or Mac a business manager, for example, can make several video speeches for the same subject before making a final decision to choose one for broadcasting to many employees. On the other hand, by using the PSU device the user must send only the initial voice or video message for broadcasting. It seems that there are more advantages to use the voice or video message broadcasting function on a PC or Mac than on a PSU device. However, when a business manager wishes to send an urgent message to many employees while he is travelling, then the PSU device would be more useful than a PC or Mac. Of course that the voice or video message broadcasting function can also be used to send a message to a single person instead of many people.

If a single phone number is selected on the advanced model PSU device, and the PSU device is switched from the portable surveillance mode to the cellular phone mode, then instead of sending a voice message to a phone recipient, the PSU device can be used for phone conversation just like a regular cellular phone. The voice and video e-mail messaging function performed by a PSU device cannot totally replace the conventional text e-mail messaging because currently a lot of business offices still rely upon the text e-mail function for their daily business operations. The design of the new PC or Mac software program for the voice or video e-mail messages broadcasting function on PC and Mac is beyond the scope of the present invention and will not be described herein.

The PSU device voice message broadcasting function may be very useful and it has several applications other than in business offices. For example, school officials may use this device to simultaneously inform many students about a schedule change due to inclement weather. City or town hall officials may use this device to send warning message to many local residents at the same time and inform them how to prepare for a hurricane or severe weather that might affect them soon. Senators or Congressmen campaign groups may use this device to send a phone voice mail to many voters at the same time which may save them a lot of time and campaign money. Church or social club members may use this device to easily notify each other about a meeting or a party event with the phone voice mail. Telemarketing companies may use this device to call many customers for a commercial ads message without needing to send a pre-recorded voice message to many people on a telephone repeatedly.

The e-mail addresses and phone numbers entered by the user on the screen 12 are stored separately in the memory chips. The e-mail addresses will always display in a sorted order above the sorted phone numbers for easy selection when they are both displayed on the screen 12. Note that the user may optionally type in the item owner name to associate with each e-mail address and phone number. The item list may be sorted by item owner names instead of by items as a default option. An alternative design may be provided as an option for a user to keep the list non-sorted as its input sequence order or sorted by the items instead of by item owner names. A PSU user who frequently employs the PSU device as a regular cellular phone may choose to display the phone numbers on top of the e-mail addresses in the list on the screen 12. The sorting mechanism of the item list can be controlled by an additional key button (not shown) on the key button pad 18 if the item list sorting function is provided.

In the emergency use mode, usually only the user of the primary e-mail account, such as the parents, will receive a copy of the PSU emergency e-mail. Thus, the PSU user does not need to press the key button F to select any other e-mail address from the screen 12 when an emergency occurs because e-mail addresses other than the pre-defined primary e-mail address will all be ignored. Two e-mail addresses separated by a comma or a blank space can be specified in the primary e-mail address field on the “Registration screen panel” if a PSU user wishes to have two persons other than the law enforcement agent at the closest local police station or a dedicated 911 center to receive a copy of the PSU emergency e-mail when an emergency occurs. If the user did not specify any e-mail address in the primary e-mail address field, then by default only the law enforcement agencies at the closest police station or a 911 center will receive a copy of the PSU emergency e-mail when an emergency occurs. The PSU emergency e-mail received files by the law enforcement agencies usually will be automatically stored in a national database which will be available as evidence when the suspect is caught and prosecuted in a criminal court for committing a violent crime.

When the SOS push button 14 is pressed, the voice and image input data received from the external microphone and external camera of the PSU device will be converted into digital signal string instantly by the CPU (not shown) and temporarily stored in the memory chips (not shown). The voice input data may come from the user or from people in the vicinity of the user. The radio frequencies in a digital signal format will then be transmitted through the antenna (not shown) of the PSU device to the destination e-mail addresses as soon as the SOS push button 14 is released. Note that the length of time that the SOS push button is pressed before release may vary from a fraction of a second to multiple seconds depending on the length of the voice and the image message to be transmitted. Thus, the SOS push button 14 must be held in while all the voice and image input data is received. If the user releases the SOS push button 14 too early, then the message data received after that will be interrupted before being sent. Even though an incomplete e-mail is sent, law enforcement agencies at a 911 center should not ignore the message and should still respond to the emergency call as usual because in most cases only the voice message file might contain partial message information, but the image message file may still contain enough clues for the law enforcement agencies to solve a crime or locate a missing person.

The transmitted digital signal string will be converted into a voice and image message files and attached to the PSU e-mail instantly by the software program installed at the central process server from where the PSU e-mail will be delivered to the pre-defined destination e-mail addresses over the Internet. Meanwhile, by default the closest local police station or a dedicated 911 center selected based on a list defined in a GPS location code cross reference chart will receive a copy of the PSU e-mail if it is an emergency call.

The GPS location code cross reference charts installed in the national database are the data files which contain the GPS location code corresponding with the closest police station, local 911 center, volunteer or professional emergency responder, local hospital, senior citizen health care center, participating life-alert or medical-alert center, or non-profit health care center, etc. These files must be very carefully designed such that every single geographic location in the entire nation would be covered and well protected. The real e-mail address name and the e-mail address code of the aforementioned organizations are assigned in these chart files which must be renamed if any of the corresponding official e-mail accounts is attacked by a hacker. These files are always kept confidential so that no hackers would be able to access these files easily, especially if these files are maintained in the mainframe computer operating system that is installed at the central process server because the mainframe computer system is always better protected than the workstation network computer system. Besides, the mainframe computer system has larger storage space and faster computing speed for storing and retrieving the archived PSU e-mail information data, which can provide a better environment for processing emergency calls efficiently. The design of the cross reference chart files for various emergency situations and the new software program running under the mainframe computer system will be managed by the PSU wireless communication system in the future and will not be described herein.

As mentioned previously, if a PSU user and his or her parents and all other family members do not have a PC or Mac and none of them or any friend has subscribed to an e-mail account then the PSU user is unable to specify a primary e-mail address on the “Registration screen panel” to receive a copy of the PSU emergency e-mail. In this case the primary e-mail address field may be left blank and the PSU emergency e-mail with the attached voice and image message files will be routed only to the closest local police station or a dedicated 911 center over the Internet by default. Meanwhile a pre-recorded voice mail will be automatically sent from the police station or a 911 center to the PSU user's home phone and notify his or her family members an emergency call has been placed by the PSU user.

There is an on/off switch 15 to power on or power off the PSU device. When the device is initially turned on for the first time, the user may place the cursor at any location on the screen 12 and press the key button A to display a “Registration screen panel” (as shown in FIG. 5A), and starts to register personal information such as the user name, gender, date of birth, home address, home phone number, primary e-mail address, and face photo picture, etc. and enter a “Registration update passcode” to protect the confidentiality of the pre-registered personal information.

When the PSU device is not in use and the cover is closed, the power of the PSU device would still remain on so that its GPS tracking function is still working. The PSU user should always keep the power of the PSU device on when he or she is carrying it for protection so that the family members or the law enforcement agencies can track his or her most current location whenever an accident or emergency occurs. When the PSU battery level is low a red warning light will be lit. Therefore, when the PSU user sees the red warning light is on, it is highly recommended that he or she should recharge the battery as soon as possible.

The software program installed at the central process server of the PSU wireless communication system can always create an e-mail to associate with the digital message signal string that is received from the voice-image message receiving station. At the top of the PSU e-mail there are five fields generated by the software program which are: the sender e-mail address field, the receiver e-mail address field, the subject field, the message date field, and the message contents field.

The sender e-mail address field usually contains the user's name followed by the user's primary e-mail address and a voice-image message receiving station code. If the user did not specify a primary e-mail address, then the sender e-mail address field will be filled with the user's name followed by user's home phone number and a voice-image message receiving station code.

For a private call, the receiver e-mail address field usually contains all user selected destination e-mail addresses from the screen 12 on the PSU device. For the emergency call, the receiver e-mail address field contains the primary e-mail address plus an e-mail address code of a closest police station or a 911 center. If the user did not specify a primary e-mail address, then the receiver e-mail address field only contains the e-mail address code of the closest police station or a 911 center but nothing else. Note that the real e-mail address name of the police station or a 911 center will not be shown in the receiver e-mail address field of the PSU emergency e-mail to prevent any hackers from attacking the law enforcement agencies official e-mail accounts. A future law will be required to severely prosecute those hackers who frequently attack the official e-mail accounts because it might interrupt the emergency call responses from 911, endanger the lives of those people who need help, and the consequence could be very serious. The official e-mail addresses and the e-mail address codes for the law enforcement agencies of all the police stations, 911 centers, or other emergency responders will all be assigned by the PSU wireless communication system in the future. The selection of the e-mail address code to be presented in the receiver e-mail address field is performed by the new software program of the PSU wireless communication system and it is based on the geographic location code generated by the GPS chipset. From the GPS location code cross reference charts, the software program can determine which police station, a 911 center, a participating volunteer or professional emergency responder, or hospital is the closest one for responding to an emergency.

As mentioned previously, the subject field in the PSU e-mail sent to the local police station or a 911 center primarily contains a very specific phrase such as “Emergency Call”. This subject field is generated by the software program when the e-mail is initially created. For the private calls, the user may press a key button (not shown) to display a “Subject screen panel” and fill in an e-mail subject title. If nothing is entered in the “Subject screen panel”, then a program generated short phrase such as “Please referring to attached message files” will be filled in the subject field automatically. At the last code line in the subject field of the PSU e-mails of the private calls, a voice-image receiving station code and a timestamp of the date and time that the message was sent from the caller and received by the voice-image message receiving station will also be displayed for the PSU emergency e-mail identification purpose.

The message date field contains the information of the date and time that the e-mail message is delivered to the primary e-mail account. It is a timestamp automatically generated by the Internet Service Provider (ISP).

For the PSU emergency call, the user's personal information, the timestamp of the date and time that the message was sent from the caller and received by the voice-image message receiving station, the PSU device unique serial number, the voice-image message receiving station code, and the GPS generated location code will all be printed in the message contents field of the PSU e-mail. If a PSU user has previously taken a face photo picture and stored in the PSU device, then that picture will be displayed in the message contents field of the PSU e-mail for the GPS tracking purposes. Moreover, the voice and image message files and the GPS generated code translated 2-D location map file will also be attached in this section. If the caller's location happens to be a tall apartment building, then a footnote must be stated below the GPS location map to explicitly indicate which floor the caller, who might be a victim of a violent crime, could possibly be found. In the message contents field, the PSU device serial number, the GPS location code, and the PSU user's date of birth will be printed in a Barcode format on a separate code line which can be used as the input data for a scanning reader of the police “GPS Tracking Machine” to read in and generate a secret passcode for GPS tracking purpose. In one embodiment, the GPS generated code translated 2-D location map is not only attached in the PSU e-mail, but may also be displayed on the viewing screen for the user to easily search for the location of the victim's current location. It should be understood that other than displaying the GPS location code, the additional feature to allow a GPS 2-D location map to be also displayed on a PSU viewing screen would increase the cost of the PSU device quite significantly.

In the private use mode, for privacy reasons the PSU user's personal information except the date of birth will not be imbedded in the PSU e-mail. The timestamp of the date and time that the message was sent from the caller and received by the voice-image message receiving station, the PSU device unique serial number, the voice-image message receiving station code, and the GPS generated location code will still be printed in the PSU e-mail, and the voice, image, or video message files will also be attached in the PSU e-mail. In the message contents field, the PSU device serial number, the GPS location code, and the PSU user's date of birth will also be shown in a Barcode format on a separate code line which can be used as the input data for the scanning reader of a police “GPS Tracking Machine” to generate a passcode for GPS tracking purposes. For the privacy reasons the PSU device serial number and birth date printed on the PSU e-mail in Barcode format should not be so easily readable to the general public. Since this is not an emergency call, the imbedded GPS generated code will not be translated into location map file. The sender's face photo picture, if there is one registered, will not be included either. However, an e-mail hyperlink icon to connect to a local police station or a 911 center will be inserted at the top of the message contents field such that when a family member or a friend discovers that the received PSU e-mail is actually an emergency call but not a private call, then he or she may quickly click that hyperlink icon to forward the PSU e-mail and attached message files to a local police station or a 911 center to ask for help.

After receiving the forwarded emergency e-mail over the internet, the law enforcement agencies at local police station or a 911 center may either check the GPS location code which is imbedded in the PSU e-mail to search for the victim at the location of the original crime scene, or use the scanning reader of a police “GPS Tracking Machine” to read in the Barcode of the victim's PSU device serial number and birth date from the PSU e-mail and send a GPS tracking request to the victim's PSU device. Then the victim's most current location can be found and the victim's life can be saved.

The method of inserting a hyperlink icon in all private PSU e-mail is a new feature provided by the present invention that can guarantee all emergencies encountered by a PSU user, including a situation where an emergency call is mistakenly sent as a private call, can be reported to law enforcement agencies.

In one embodiment, the new software program of the PSU wireless communication system may be designed to implement a secret code in non-readable format which will be generated by a secret formula based on the imbedded code in the PSU e-mail. This secret code plus a size code of the PSU e-mail and two size codes of the attached voice and image message files will all be imbedded in the PSU e-mail which is typically unknown to anybody who operates the PSU device. In addition, for verification purposes the same secret code will also be imbedded in the source code of the attached message files and the PSU wireless communication system record log entries. The method of planting the secret code and size codes in the PSU e-mail file as well as the attached message files which is undetectable to PSU owners, is for the purpose of maintaining the originality of the PSU emergency call e-mail file and enabling its associated voice and image message files to be kept together as legal document for the forensic evidence, if desired. Any minor changes in the contents of the PSU e-mail or attached message files by anyone using an editor can be detected by a special software program which is included in this PSU wireless communication system. This special software program is available only to the authorized persons who seek forensic evidence produced by the PSU device, and it is accessible only from a package produced by the manufacturer who will develop the software programs for this PSU wireless communication system. It is a unique feature provided by the present invention which can prevent any person from perjuring the document produced by the PSU device and creating illegal fake forensic evidence. Sometimes the PSU e-mail message file produced by the PSU device might be the only evidence available for prosecutors in a court. It is anticipated that the e-mail produced by the PSU device will be the most reliable source of evidence to be used by attorneys to defend a plaintiff, who may be either a victim or the victim's family member, in a criminal court or civil court.

The FBI or other law enforcement agencies may broadcast the photo pictures of the suspect taken from the external camera of the PSU devices and the victim's face photo picture imbedded in the PSU emergency e-mail on several TV channels and request the general public to identify the suspects for them and assist them to search for the victim. By doing so they may capture the suspects and rescue the victim, and easily solve the violent criminal cases.

Returning to FIG. 1B, when the key button G is pressed to set the PSU device for private use, then this system will not send a copy of the PSU e-mail to any law enforcement agencies. Without pressing the key button G again to reset the device back to the default emergency use mode, the user may still be able to place an emergency call in private use mode simply by pressing either end position N (as shown in FIG. 1D) of the SOS push button 14. In other words, if a user always presses the end position N of the SOS push button 14 while sending out a message, the local police station or a 911 center will receive a copy of the PSU e-mail no matter if the PSU device is set to private use mode or emergency use mode.

Since the PSU device is so easy to operate, it might be expected that 911 centers could be overwhelmed with a high volume of non-emergency calls sent from users, especially those who are young and do not realize the consequences of their actions. The calls that are mistakenly placed in an emergency use mode may overload the volume of work for a 911 center and reduce its efficiency to respond to real emergency calls. Thus, it is recommended that the PSU user should always press the key button G on the key button pad 18 to set the PSU device to private use mode if an advanced model PSU device instead of a basic model PSU device is used. Similar to the subscriptions of a regular cellular phone, the user who operates the PSU device for private calls will need to pay a monthly fee for phone services.

To improve the response time to emergency calls, the 911 rescue team that receives an e-mail message transmitted from the PSU device may need to give a higher priority response to calls containing a voice message and assign a lower priority to image messages without a companion voice message. It should be appreciated by those skilled in the art that a future law may be required to prosecute people who constantly make false PSU emergency calls by mistake which can cause severe interruptions of real emergency responses from 911.

Returning to FIG. 1D, note that the top of the SOS push button 14 is not a flat surface and it is in slightly curved shape such that when a user touches the SOS push button he or she can easily tell apart the center position M and the end position N on the SOS push button. Therefore it is highly recommended that the users of the PSU device should always set the PSU device to the private use mode to avoid from placing a private call to an emergency call by mistake.

While pressing the SOS push button at the center M position, the user may still be able to switch to N position before releasing the SOS push button to send an emergency call. The type of PSU call is determined by the final finger position between the M and N positions before the SOS push button is released. Sometimes the user may switch back and forth between these two positions on the SOS push button several times within a second before making a decision which type of the message, i.e. the message for emergency call or private call, will be sent out if the PSU device has been previously set to private use mode. For emergency calls, the user is highly recommended to always send a PSU call by pressing the SOS push button at the N position, i.e. at the end position, no matter if the PSU device has been set to emergency use mode or private use mode.

The PSU device has the portable surveillance capability which not only can be used to protect the owner of the PSU device, but also can be used to protect another person who is walking or standing nearby. Suppose a PSU user is an eyewitness of a crime or accident such as robbery, murder, kidnapping, or hit and run car accident, then it is up to the user to either press the M or N position of the SOS push button 14 to send an emergency message to the closest local police station or a 911 center, or send a message to home if his or her PSU device has been set to private use mode. If a PSU user decides to press the SOS push button at the M position to send the message with all picture evidence to home as a private call first, and makes a decision to click the hyperlink icon to forward the e-mail to a local 911 center later, then it would cause a delay for the law enforcement agencies to investigate the crime. Sometimes a delay in transmission of the evidence to law enforcement agencies might cause loss of the victim's life. Thus, the PSU user should never hesitate to press the SOS push button at the N position to send an emergency call to a 911 center when an emergency occurs to a person nearby. The PSU user should always have enough courage to be an eyewitness to help the law enforcement agencies to fight against violent crimes. If all citizens would help each other to fight against various crimes, eventually all the crimes might be stopped.

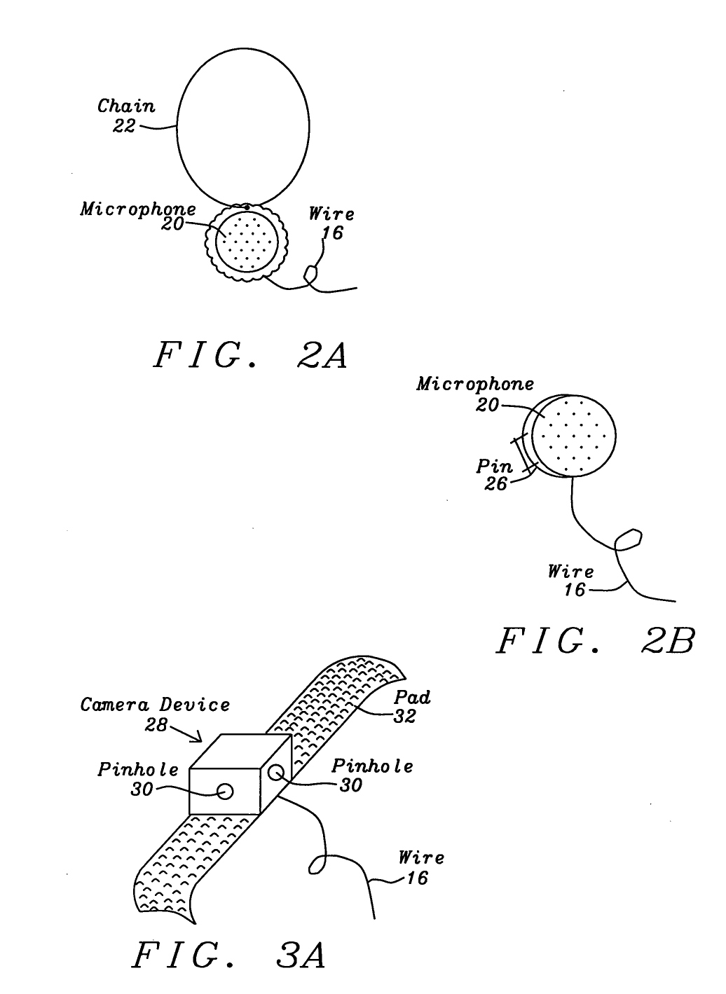

Referring to FIG. 2A, one possible design of an external microphone 20 is shown. In one embodiment, the external microphone is essentially a circular element having top and bottom surfaces and a continuous side that connects the top and bottom surfaces. The top surface has holes therein that allow sound to be received in the form of the user's voice or from a nearby source. The external microphone 20 is able to communicate with the CPU in the base portion 11 by either a wire 16 or wireless connection and thereby transmit audio input. A chain 22 may be attached to the side of the external microphone 20 in the same shape as a necklace that allows the user to wear it around the neck. There may be various kinds of decorations affixed to the side of the external microphone. In one aspect, the decorations may be configured to cover the external microphone for the purpose of concealment.

A second possible design for the external microphone 20 is depicted in FIG. 2B. The external microphone may be circular in shape and flat like typical shirt buttons. The external microphone 20 has top and bottom surfaces and a continuous side as in the first design with holes in the surface to permit sound entry. There is a pin 26 attached to the bottom surface of the external microphone 20 as a means of fastening the external microphone to an article of clothing worn by the user. A wire 16 may be used to connect the external microphone 20 to the PSU device, if necessary.

When an emergency occurs, the user may quickly grab the PSU device and press the SOS push button 14 firmly at either position M or N, and then start talking. After a short voice message is completed the user may release the SOS push button 14 to send the message out. The present invention also anticipates that the user may press the SOS push button 14 to record and transmit a potential attacker's voice for identification purposes.

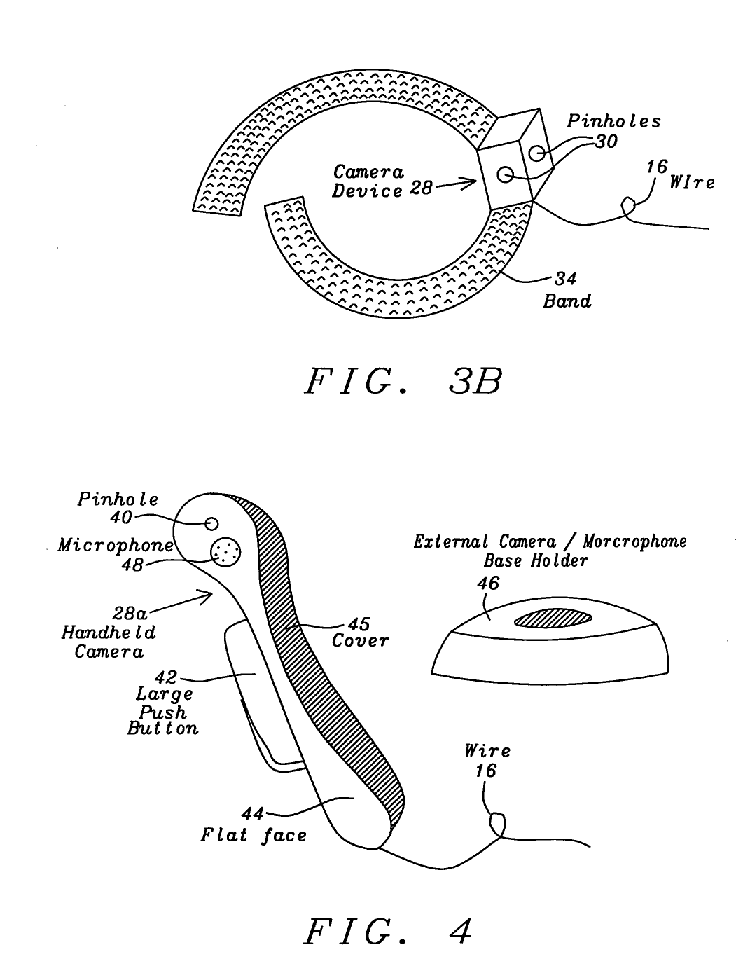

An external camera may be employed as an additional accessory to the PSU device. The camera design may come in several different shapes. In FIG. 3A, a small external camera device 28 is depicted with 2 or 3 pinholes 30. In the exemplary embodiment, there are two small pads 32 underneath the external camera that may be employed to attach the external camera device to a shoulder of the user. A wire 16 may be used to connect the external camera device 28 to the PSU device, if necessary. In one embodiment, the external camera device 28 may be concealed by the ornament or decoration as discussed previously with respect to the external microphone 20.

Referring to FIG. 3B, another shape of the small external camera device 28 with 2 or 3 pinholes 30 is depicted. In one aspect, there are two bands 34 made of Velcro strips that attach the external camera device around an arm of the user. Alternatively, other types of fasteners may be selected which hold the external camera in a position that is convenient and comfortable for the user. For example, the external camera device may be attached to a belt, a pair of glasses, or a hat worn by the user.

The lenses (not shown) of the external camera device 28 must be very sensitive in order to allow photo pictures to be taken with relatively clear results even in low light conditions. Preferably, the external camera lenses should be capable of taking photo pictures in wide angle so that the user does not need to worry about centering a shot under stressful conditions. The shoulder pad and the arm strips of a multiple pinhole external camera device 28 are preferably very small in size so as not to be easily detected by a potential attacker.

The diagrams as shown in FIG. 2A, FIG. 2B, FIG. 3A, and FIG. 3B are the examples of the external pats that can be connected to the PSU device either by a wire or wirelessly. In one preferred embodiment, each of these parts may be designed to have both of the external microphone and external camera to be bound together with various kinds of decorations for concealment purpose if these parts are made in very small size.

Assuming the advanced technology already exists to enable a wireless connection between an external camera and external microphone to the PSU device, the connection wire 16 would not be necessary. In this case, the external microphone 20 and external camera device 28 may be hidden in a hat, a pair of eye glasses, a tie clip, a wrist watch, a finger ring, or other clothes or jewelry items without being easily detected by potential attackers.

In general, the price of the PSU device with a wireless external camera and external microphone components is considerably higher than a wired connection version. However, the wireless connection between an external camera and external microphone to the PSU device is usually much preferred over the wired connection version. The reason is that when an attacker seizes a victim, he may not be able to easily detect that the victim is carrying a PSU device. Therefore, it is unlikely the attacker will rob or steal the wireless device from the victim and throw it away. Thus, even if the victim is under attack the law enforcement agencies may still be able to search for the victim's most current location. On the other hand, the wired connection device would increase the risk of being identified by the attacker which could cause the victim to lose the PSU device, and may even cause the victim loss of life because the law enforcement agencies are unable to find the victim for a timely rescue. It should be understood that both wired and wireless PSU devices can capture the photo images of the suspect with the same efficiency.

When an emergency occurs, the user may quickly grab the PSU device and press the SOS push button 14 firmly at position M or N, depending on whether or not the device has been set for private use mode by the key button G. A photo image will be taken in every few seconds as long as the SOS push button 14 is pressed and not released. If the SOS push button 14 is released in a very short period of time, then there will be only a single photo image frame collected and transmitted instead of two or more frames. However, if the SOS push button 14 is pressed long enough, then every few seconds the input photo image taken during a particular interval, which is in the analog signal format, will be instantly converted into digital signal format by the CPU and temporarily stored in the memory. When the SOS push button 14 is released, a CPU constructed output digital signal string which contains all the stored photo images will be transmitted in a second or less to the closest voice-image message receiving station where the digital signal string will be parsed and converted into image message file, and then the message file will be attached to a PSU e-mail and sent to the pre-defined destination e-mail addresses over the Internet. Note that the image and voice input data are always received from the external camera 28 and the external microphone 20 at the same time. In a preferred embodiment, the image and voice output data from the PSU device will be sent simultaneously in the same digital signal string to the closest voice-image message receiving station. However, the present invention also anticipates that the users may not wish to speak if they are in a dangerous situation and do not want to draw attention from a potential attacker. In this case, the PSU emergency e-mail will contain an image file of the attacker's face photo picture and a voice message file that only has the background sound comprised of voices from surrounding people.

In one embodiment, the PSU device may be equipped with a three-way toggle switch 17 (as shown in FIG. 1A) which is preferably on the top surface of the base portion 11. This is a unique feature of the PSU device that allows the user to select whether to send a voice message only, send a photo image message only, or send both voice and image messages simultaneously depending upon the toggle switch bar position. The default setting of the toggle switch bar is in the middle position which enables both voice and image messages to be sent when the SOS push button 14 is released. Optionally, the toggle switch bar may be moved to either of the end, and thereby allow only one type of message to be transmitted. For example, a manager who is out of the office and wants to send an oral instruction to his secretary during non-work hours would likely select the send voice message only option on the toggle switch bar. On the other hand, a tourist may select the send photo image message only option on the toggle switch bar and operate the PSU device as a digital camera.

In another preferred embodiment of the advance model PSU device, a Secure Digital High Capacity (SDHC) memory chip may be added so that pictures of scenery or friends, for example, can be stored in a SDHC memory chip if the PSU device is set for private use mode and the toggle switch is set to image only position. In this case, the PSU device may be used as a regular digital camera. It should be understood that this new feature of digital camera with a SDHC memory chip implemented in the PSU device would increase its cost significantly. However, the quality of the pictures taken from the PSU device is expected to be as good as from a regular digital camera.

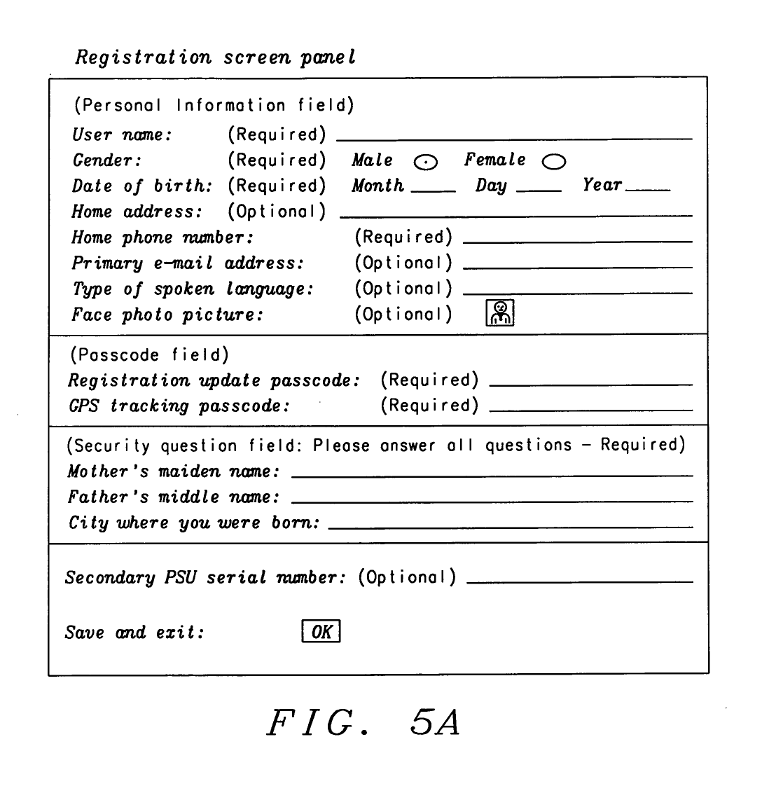

Referring to FIG. 4, an alternative external camera device may be designed in a handle bar shape. In one aspect, the handheld camera device 28a is comprised of a substantially flat face 44 and a curved portion or cover 45 that functions as a grip for the user to hold the external camera device. One or two camera pinholes 40 may be positioned at one end of the flat face 44. On the cover 45 of the PSU device a large push button 42 is equipped which performs exactly the same function as the push button 14 previously described. A wire 16 can be used to connect this handheld camera device 28a to the PSU device, if necessary. The diagram in FIG. 4 also includes an external camera and external microphone base holder 46 which allows the handheld camera device 28a to be put on it, and it can be connected to a PC or Mac with USB and used as an external webcam with microphone for the PC or Mac.

When an emergency occurs, instead of grabbing the PSU device, the user may quickly take the handheld camera device 28a and point the camera pinholes 40 toward the desired direction. Then the user may press the push button 42 to take photo pictures of a threatening person or potentially dangerous surroundings. A small external microphone 48 may be incorporated on the flat face 44 if the user wishes to send a voice message. Obviously, in this embodiment the external microphone 20 described earlier may not be necessary because there is a handheld camera device 28a having a small built-in external microphone 48 that can be used to communicate with the base portion 11.

The large push button 42 on the handheld camera device 28a and the SOS push button 14 on the PSU device perform the identical function. Therefore, when the push button 42 is pressed the user does not need to press the SOS push button 14 again to send a message. By pressing either end of the large push button 42 similar to the SOS push button 14, the user may still be able to send an emergency message when the PSU device has already been set to private use mode. Note that the large push button 42 has the same feature as the SOS push button 14 but the middle and ends are not labeled in the diagram of FIG. 4.

The advantage for a child to use the handheld camera device 28a is that it is much easier for the child to take a clearer picture of the potential attacker than other type of camera components provided by the PSU device when an emergency occurs. The disadvantage of this device is that it is much easier for the suspect to detect that a child victim is carrying a PSU device and quite possibly he will rob or steal the device from the child and throw it away after the attack. In one embodiment, the handheld camera device 28a may be designed to be equipped with an alarm device (not shown) such that when the push button is pressed by the child it will trigger the loud alarm sound to scare the perpetrator away which might deter the attack in the first place. If the push button is pressed by the child accidentally that turns on the alarm loud sound by mistake, then a small button (not shown) at the side of the handheld camera device 28a may be touched to silent the alarm right away. This alarm device may also be added to the external parts as shown in FIG. 2A, FIG. 2B, FIG. 3A, and FIG. 3B or on the PSU device if the alarm device can be made in very small size.

There are two types of internal memory chips (not shown) in the PSU device. One is static memory chips and the other is dynamic memory chips. The capacity of static memory is relatively much smaller compared with dynamic memory and may be used for storing the input text data such as the user name, gender, date of birth, home phone number, home address, primary e-mail addresses, the type of spoken language, and the face photo picture, etc. which are entered from “Registration screen panel” of the PSU device by the user during the pre-registration phase. The PSU device is powered by a re-chargeable battery (not shown) within the base portion 11 similar to the regular cellular phone. The data stored in the static memory will not be flushed and lost even if the battery is drained or the power of the PSU device is turned off using an on/off switch 15. The capacity of the dynamic memory chip must be large enough to hold the converted digital voice signals received from the external microphone 20 or 48, the converted digital photo images signals taken from the external camera device 28 or 28a, and the CPU constructed voice and image output digital signal string altogether simultaneously. All the data in dynamic memory will be flushed and the space will become re-usable as soon as the output digital signal string data is transmitted out or when the power of the PSU device is turned off.

In one preferred embodiment, the capacity of the internal dynamic memory may be expanded to 4 GB or larger to provide a better processing function. Instead of transmitting the digital signal string to the local voice-image message receiving station with the separated voice and image message files in a PSU e-mail, such as “.wav” and “.jpeg” files, the large capacity of the memory chip would enable a large sized video message file to be generated in a “.mpg”, or “.avi” file format.

The aforementioned format using the video camera to combine the voice and image digital signal data into one video file like a motion picture file can provide much more effective audio and visual information for forensic evidence. This embodiment provides functionality similar to a camcorder. In this case, the end positions of the three-way toggle switch of the PSU device will still be set to be either the voice only or the image only modes, but the center position which is the default position, may be set to video mode instead of both voice and image mode.

It should be understood that the larger sized memory chips implemented in the advanced model PSU device for the video emergency call function would increase its cost tremendously. However, it might be worthwhile because the video PSU emergency e-mail contains more accurate and detailed forensic evidence which can help the law enforcement agencies to find clues much easier and solve the criminal cases much faster.

The PSU device is equipped with a built-in clock (not shown) in the base portion 11 to provide an accurate time code of the message being sent. Similar to the regular cellular phone, the date and time of the internal built-in clock implemented in the PSU device is always synchronized with the system clock that is implemented at central process server of the PSU wireless communication system automatically whenever the PSU device is turned on or a special button called “Clock” button (not shown) on the key button pad 10 is pressed. Therefore, the built-in clock of the PSU device should never be adjusted manually by the user. However, the user may need to turn off the PSU device and turn it back on sometimes or simply press the “Clock” button once for a while to make sure the date and time of the PSU device has been already synchronized with the clock at the central process server. The date and time of the clock is displayed on both of the cover 13 and the screen 12 of the PSU device. The user may check the PSU device for the time of the day without needing to open the cover of the PSU device. The time of the day shown on the PSU device is generally more accurate than the time displayed on a wrist watch.

In view of the existing internal memory chips and CPU in the advanced model of the PSU device, a minor modification and a few additional keys may be added to the keypad 10 to upgrade the advanced model of the PSU device to perform like a handheld PDA device with the features such as a daily planer book, address book, pocket notebook, video games, and calculator functions as appreciated by those skilled in the art. It should be understood that the PDA-like features implemented in the PSU device are not related to the emergency call functions and those features would increase the cost of the PSU device also.

In another embodiment, the PSU device may include an advanced function that allows software programs similar to an Internet Web Browser to be employed. This advanced function enables the PSU user to read and respond to a PSU e-mail sent from other user over the internet, and he or she may watch the information from the attached image message file directly on the screen 12 of the PSU device. A sound card (not shown) may be incorporated in the PSU device to allow the user to hear sound from an attached PSU voice message file from a phone speaker. In addition to the phone conversation capability, this advanced function allows the user to achieve two-way voice and image e-mail communication with other user. Capability of reading PSU e-mail messages has already been provided by various Internet Web Browsers on a regular PC or Mac. The software necessary to support the Web Browser function on the cellular phone, such as the Windows phone, is believed to already exist and will not be described herein.

The present invention is also a system comprised of the previously described voice and image e-mail transmitter device, i.e. the PSU device, at least one tower for transmitting the voice and image digital signals, and a voice-image message receiving station comprised of the software program that is capable of parsing out the voice and image information from the received digital signal strings and create the PSU e-mail there from. The tower is preferably a cellular phone tower which is at a location that can relay signals received from both of the cellular phone and the PSU device, and this process may be performed in about a second by the new software program installed at the local processing central server. The PSU wireless communication system also includes a new PSU phone number dialing system that uses the PSU device serial number as the phone dialing number which can be used in a new GPS based people tracking system to search for the most current location of a missing person who may be the victim of violent crime.

Many types of the GPS device tracking methods for the 911-enabled wireless communication network that is necessary for locating the GPS device and also for searching missing persons are believed to already exist. Some of the methods rely upon the dual satellite technology to directly locate a GPS device; the others rely upon the wireless communication systems to track a GPS device. However, none of those methods has provided the function to prevent the unauthorized people from tracking the person who is the owner of the GPS device.

Currently, the law enforcement agencies may dial the phone number of a victim's Smartphone, for example, and the software in the Smartphone may respond with the GPS location information of the missing person who is the owner of the Smartphone. The concept similar to the GPS tracking method applied to the Smartphone has been adapted by the PSU wireless communication system in the present invention because it allows an additional GPS tracking passcode feature to be added to improve the security function of this GPS tracking system. This improved GPS tracking system also users a new PSU phone number dialing system which applies the PSU device serial number as the phone dialing number.

Other than the portable surveillance system, the present invention also encompasses another system associated with a new PSU phone number dialing system which uses the unique serial number of the PSU device instead of the existing regular phone number as the phone dialing number. This new PSU phone number dialing system provides the GPS tracking capability for the PSU device to assist family members and law enforcement agencies to search for a missing person who is a PSU user and also may be a victim of violent crime.

The aforementioned new GPS based people tracking monitor device named “GPS Tracking Machine”, which is upgraded from the regular “Auto GPS Navigator” device, can be used for tracking the missing persons. The police “GPS Tracking Machine” device has a scanning reader which can be used to read the GPS generated location code in a Barcode format from a PSU emergency e-mail and the software installed in this new device can translate the GPS generated code into 2-D location map which can be displayed on the monitor screen to show the location of the original crime scene of the victim. The scanning reader should also be able to read the hand-written regular numbers other than the Barcode numbers. The GPS generated location code to be read in will be stored in this “GPS Tracking Machine” so that the user may apply this device as an “Auto GPS Navigator” to select the GPS location code converted address as the new target destination to search for the location of the victim while driving a car. This device can generate a four-digit pin number of the secret “GPS tracking passcode” to search for the most current location of the victim based on the victim's PSU device unique serial number and the victim's birth date from a Barcode on the victim's PSU e-mail so that it can track the victim without needing to know the victim specified “GPS tracking passcode” on the PSU device.

This special “GPS Tracking Machine” device is equipped with a police badge reader and will be sold to the police stations or 911 centers only. A law enforcement agent who needs to use the police “GPS Tracking Machine” device to track a victim's location must sign in to this device with a police badge. A law enforcement agent may use the police “GPS Tracking Machine” device to dial the victim's PSU device serial number directly without specifying any passcode and it can send a GPS tracking request to the victim's PSU device using a machine generated four-digit secret passcode. When the victim's PSU device receives a GPS tracking request, it will respond with the GPS location code and send back to the police “GPS Tracking Machine” device directly such that the police “GPS Tracking Machine” device can automatically set a new address corresponding to the victim's new location as a target address. It allows the police to pursue the suspect by sending the GPS tracking requests from the police “GPS Tracking Machine” device continuously while driving a car until the victim is found and rescued. This method of the direct communication between the police “GPS Tracking Machine” and the victim's PSU device is a new feature disclosed in the present invention. It is the best method that can assist the law enforcement agencies to capture the suspect, which might be a moving target, very efficiently.

The price of the police “GPS Tracking Machine” device may be too expensive for many people. Another civilian version of this special “GPS Tracking Machine” device without a scanning reader and a badge reader will be needed for the general public. Since it does not have the scanning reader and police badge reader equipments, thus it is a lower cost device comparing with the price of the police “GPS Tracking Machine” device. The user of this civilian “GPS Tracking Machine” device must manually type in the victim's GPS location code in regular decimal number format from an on-screen menu to reset the target destination address in the civilian “Auto GPS Navigator” device to a new address. The GPS location code may be obtained from the victim's responded PSU e-mail of a GPS tracking request over the internet. With that information, the user may employ the civilian “GPS Tracking Machine” to track the location of the victim while driving a car. The civilian “GPS Tracking Machine” device does not have the capability to send a GPS tracking request. The user must use a PSU device and dial the victim's PSU device serial number followed by a plus-sign and a “GPS tracking passcode” to send such a GPS tracking request. The PSU user may select a “GPS tracking item” on the PSU device to send a GPS tracking request to the victim's PSU device and from the victim's responded PSU e-mail the PSU user may contains the most current location code, which is in a pair of regular decimal number format, of the victim. Then the PSU user may type in the GPS location code from the on-screen menu on a civilian “GPS Tracking Machine” device to track the most current location of the missing victim. Thus, the combination of the functions of both of the PSU device and civilian “GPS Tracking Machine” is equivalent to the function of the police “GPS Tracking Machine” device.

The similar function that allows the user to type in a pair of GPS coordinate code from the on-screen menu on a GPS device to set a new target destination address like the civilian version “GPS Tracking Machine” device seems to be quite fundamental and it might have already provided by some commercial “Auto GPS Navigator” devices. This function is a very important feature of the present invention because it can help the family members to locate their missing loved one while they are driving a car. The person they are searching for is a PSU user, who is missing and may be a victim of violent crime. This type of civilian monitor devices is also a very useful tool to help a person to drive to a location of a family member or friend who uses a PSU device to guide them to drive to the target destination address.

The software program installed in the civilian “GPS Tracking Machine” device may also be available on a website so that people who cannot afford to buy such a civilian “GPS Tracking Machine” device may log in to this website with a free member subscription and type in a pair of GPS location code, i.e. the latitude and longitude code, from an on-screen menu of this website to display the location map to search for a missing person. Many websites of this type are already available on the Internet, and they all can accept various kinds of GPS coordinate code format as input data. An official website dedicated to the PSU device that only accepts the GPS coordinate code pair generated by the PSU device will be provided. The GPS location code translated 2-D map of the victim's location will be displayed when the user types in a pair of the valid GPS location coordinate codes generated by the PSU device from the on-screen menu in this website. The design of such an official website will be managed by the PSU wireless communication system in the future and will not be described herein.

The “Auto GPS Navigator” manufacturer companies may consider modifying the hardware components of the existing “Auto GPS Navigator” device and upgrade the software to provide additional on-screen menu to allow the users to type in a GPS generated location code, which can be obtained from the PSU emergency e-mail, such that the users may track the location of a family member who is either missing or travelling out of town. The new upgraded “Auto GPS Navigator” device, which is also called the “GPS Tracking Machine” as mentioned before, not only can be used by the general public but also can be used by the law enforcement agencies. This new machine is a very useful device for many people, and it could be quite profitable if it is proven to be very helpful for saving many people's lives. If the civilian “GPS Tracking Machine” device is not being used for tracking the missing people, it may just be used as a regular “Auto GPS navigator” device when the person is driving a car.

The following are the major differences of the functions of the PSU device and the “GPS Tracking Machine” device:

1. The PSU is similar to a regular cellular phone. The basic and advance model PSU devices can provide the portable surveillance function. The “GPS Tracking Machine” device is upgraded from the regular “Auto GPS Navigator” device and it does not have the portable surveillance capability.

2. Both of the PSU device and the police “GPS Tracking Machine” device can be used to send a GPS tracking request to a victim's PSU device. The PSU device needs to specify a valid victim pre-defined “GPS tracking passcode” while using the new PSU phone number dialing system to send a GPS tracking request. The police “GPS Tracking Machine” does not need to specify a “GPS tracking passcode” because its scanning reader can read in the Barcode of the PSU serial number and birth date from the victim's PSU emergency call e-mail and generates a secret passcode for the GPS tracking function. Of course, the police “GPS Tracking Machine” device can also send a GPS tracking request with a valid passcode similar to the PSU device. The civilian “GPS Tracking Machine” does not have the capability to send a GPS tracking request, but the user can type in a GPS location code from an on-screen menu of this “GPS Tracking Machine” device to reset the old target destination address to a new one.

3. The police “GPS Tracking Machine” device can receive a GPS location code from the victim's PSU device directly and reset the target destination address automatically such that it can be used as an “Auto GPS Navigator” device to guide the police to search for the missing victim continuously while in a moving vehicle. The PSU user needs to use a PSU device to send a GPS tracking request to the victim's PSU device in order to obtain a new GPS location code from the victim's responded PSU e-mail and then uses the civilian “GPS Tracking Machine” to search for the missing victim continuously while driving a car. The combination of a PSU device and a civilian “GPS Tracking Machine” device can perform the same function as a police “GPS Tracking Machine” device.

4. Both of the PSU device and the “GPS Tracking Machine” device can be used to track the location of a simplified PSU device in order to find a valuable asset or a toddler. These two devices can also be used to search for a person who is carrying a simplified PSU device as secondary PSU device for protection.

Note that the GPS phone and the civilian “GPS Tracking Machine” are different devices. The advanced model PSU device that combines the GPS phone and the basic model PSU device, which is a PSU phone, is not the same as the civilian “GPS Tracking Machine”, either. The design of the PSU phone with the “GPS Tracking Machine” capabilities which is similar to the civilian “GPS Tracking Machine” device is beyond the scope of the present invention and will not be described herein.

As mentioned previously, the law enforcement agencies may use the scanning reader of the police “GPS Tracking Machine” device to read in the victim's PSU device serial number and birth date Barcode printed on the victim's PSU emergency e-mail and generate a four-digit secret passcode to search for the location of the victim. In case that a PSU user did not have a chance to place a PSU emergency call to a 911 center when an emergency occurred, and the family members feel that the loved one might be missing since they could not find him or her for a long time, then they may write down the serial number and passcode of that person's PSU device on a piece of paper and bring to the law enforcement agent to request for using the scanning reader of a police “GPS Tracking Machine” device to read in the hand-written information or manually type in the victim's PSU device serial number and the pre-specified passcode from the on-screen menu of the police “GPS Tracking Machine” device to search for that missing person.

A pendant or a watch component with a built-in waterproof microphone and speaker may be wirelessly connected to the advanced model PSU device to allow the senior citizens, who need to live alone or need to temporarily move to somewhere else to live, to wear it all the time. Whenever they fall and are unable to move, they can just press a button on the pendant or the watch to send a short verbal message to contact with a local hospital, a participating life-alert or medical-alert company, or a local non-profit volunteer health care organization to ask for urgent help. The voice message will be converted to a voice message file by the new software program and attached to a PSU e-mail which contains the personal information of the senior caller and a GPS location map which shows the senior caller's most current location.

Currently, the life-alert and medical-alert systems owned by private companies for saving the lives of senior citizens already exists in United States but may not be available nationwide yet. The phone installations to connect their systems for senior citizens are usually very expensive and it is not reloadable. Senior citizens who need such protection also need to sign a contract and pay a high monthly fee. Therefore, not every senior citizen can afford to pay for the service. The emergency help function provided by the PSU wireless communication system to help save the lives of senior citizens is not only portable but is also less expensive which allows the existing life-alert and medical-alert systems to be affordable to all senior citizens thereby enabling such emergency help systems to be expanded nationwide.

This PSU wireless communication system contains various features that can combine the emergency help function for saving the lives of senior citizens and the portable surveillance function for saving many people's lives into one integrated life-saving system. The aforementioned senior citizen life saving system using the pendant or watch as a communication tool is just an example to show that the PSU wireless communication system can be expanded to perform many different types of emergency help functions. In fact, any type of emergency situation can be integrated into the PSU wireless communication system simply by modifying the contents of a GPS location code cross reference chart in the national database for the new software program of this system to deliver the PSU e-mail to different destination addresses other than local police stations, a 911 centers, or a local hospitals whenever an emergency call is placed by a user who uses the PSU device for different types of emergency situations.

In one embodiment, the advanced model PSU device may be designed to be used by military service departments. The PSU devices can be distributed to a group of soldiers and put under their helmets so that a commander may deliver a verbal command to many soldiers in the battle field simultaneously in the voice mail format via the speaker of the PSU device if a list of the phone numbers of the soldier's PSU devices is selected from the commander's PSU device. The new GPS tracking function provided by the PSU device can also be used to assist military officers to track the location of soldiers who are missing in the battlefield. This military application function is very useful, and it is similar to the aforementioned business office voice message broadcasting function.

Note that the device type codes in the PSU device serial numbers for senior citizens and for military soldiers are different from the device type code of the PSU devices for the general public. Therefore, the GPS location code cross reference charts for the different device types of PSU devices are also different. The GPS location code cross reference charts implemented in a national database at the central process server can determine where the closest target destination for which type of the PSU e-mail or voice mail will be sent. For the general public, the target would be the closest police station or a 911 center. For the senior citizens, the target would be the closest hospital, a participating life-alert or medical-alert center. For the military soldiers, the target would be the nearest military headquarters or a local combat unit. The GPS location code cross reference charts are maintained by the authorized operator of the PSU wireless communication system and the target selection is processed by the new software program based on the GPS location code in the cross reference charts, which are the list files implemented at a national database. In one embodiment, a selector (not shown) for the emergency function selection may be equipped on the PSU device so that the PSU user may decide what type of emergency reporting function the PSU device can perform in the future.

Usually, the emergency call placed by a PSU user does not need to wait for a verbal response from a 911 operator because there is no time for the PSU user to wait for such verbal response when an emergency occurs. Other than the forensic evidence in photo pictures provided by the PSU devices, this is another major difference between the regular 911 emergency phone calls and the PSU emergency calls. Most of the Smartphone currently sold on the marketplace are already equipped with a single push button for 911 emergency calls, but those emergency calls may not be free of charge and the users must always wait for a vocal response from a 911 operator whenever they place an emergency call to 911 using the Smartphone. One disadvantage of the Smartphone and other conventional phone calls to 911 is they always need to take quite a lot of time to complete a single emergency call. Currently none of the Smartphone is equipped with an external camera for the caller to capture a photo picture of the potential attacker and transmit the picture to a 911 center immediately within just few seconds in an e-mail format for the forensic evidence whenever an emergency occurs. Thus, relying upon the Smartphone for a full life-saving protection is essentially impossible.

To build a new PSU phone number dialing system which uses the PSU device serial number as the new phone dialing number for the new improved GPS based people tracking function on the PSU wireless communication system is a very large and expensive project, and it may be a quite challenging task. Although one could consider modifying the software operating system in the Smartphone, adding an external camera and external microphone to the Smartphone to imitate the portable surveillance function in a PSU device, and continue to use the existing regular phone number dialing system on Smartphone to track the location of missing person as an alternative to replace the ideas provided by the present invention. However, that consideration is not believed feasible because the price and monthly service fee of Smartphone are usually too expensive for average income families. Most families with young school children simply cannot afford to buy an expensive Smartphone just for emergency calls. Therefore, it is quite possible that many people's lives may not be able to be saved when an emergency occurs because they cannot afford to buy a Smartphone. It will be an unfortunate situation and also a serious problem which will need to be resolved. Besides, the existing phone number dialing system that may work for the GPS tracking function in one country may not work for other countries, and is really not desirable for tourists who wish to carry only one GPS protection device while travelling at many countries in the world. Thus, to include such a new universal phone number dialing system for a globally used GPS tracking function in the PSU device instead of using the modified Smartphone as the life protection device is extremely desirable and is a substantial cost advantage.

The design of the PSU wireless communication system of the present invention is not restricted to only adapt the concept of the existing phone number dialing method currently applied to the Smartphone to perform the GPS tracking function. If the dual satellite technology, which can be used to locate a GPS device directly without the wireless communication network interface, does allow the additional passcode security feature to be included in the GPS tracking function, and if it can be developed with a lower cost for all nations to use, then the concept of the dual satellite method might be a better idea than the new PSU phone number dialing method to be adapted by the PSU wireless communication system in the future. The designs of the dual satellite method for the GPS locator function is believed to already exist and will not be described herein.

There are two methods can be selected for validity checking of the “GPS tracking passcode” of a PSU device to improve the security feature of the GPS tracking function. One is to check the passcode using CPU in the PSU device when a GPS tracking request is received, and the other is to check the passcode by the new software program that is installed at the central process server when a GPS tracking request is responded to. The detailed design of the passcode verification function will be managed by the PSU wireless communication system in the future and will not be described herein either.

As the PSU device can provide the very critical life-saving function to protect many people efficiently, there will be preferably only one type of this system available in the entire world in the future so that all tourists and travelers will not need to carry more than one unit of such device for their protection. Requiring travelers to always carrying multiple units of the protection device for many different portable surveillance systems produced by many manufacturers would cause them feel very confused. Suppose a traveler makes a mistake one day and presses the button of a wrong device while travelling in a country when an emergency, such as robbery or abduction, occurs, then it might cause him or her to be unable to get help at all, which could create a serious fatal incident. Therefore, it is highly recommended that consumers must refuse to purchase any product associated with an imitation system which claims to be able to perform the same protection function as this PSU wireless communication system, if there will be any, and they should only rely upon the PSU device and the PSU wireless communication system to save their lives.

Several GPS based people tracking devices are already available on U.S. marketplace today. However, none of the devices support the portable surveillance function and all are sold at a very high price just like the Smartphone. Some customers who bought such devices also need to pay a high monthly fee for a limited amount of services provided only from those privately owned companies. The purpose of the present invention is to establish the most efficient wireless communication life-saving system and provide a reasonable low cost PSU device for all people in the world to protect themselves and fight against violent crime. Therefore, this PSU wireless communication system and the associated PSU device should be developed even though some of the devices that can provide part of the functions similar to the PSU device already exist.

During peaceful times when the national crime rate of every country in the world is low, many people might feel that violent crime may never occur to them or to any one of their family members. They usually don't believe a dangerous situation could happen, and they don't believe there is need to purchase any device for protection at all, especially during the time when the prices of various GPS protection devices available on the marketplace are all very high. However, their thoughts do not mean the aforementioned serious problem does not exist. The PSU wireless communication system disclosed in the present invention can provide the GPS protection device that is affordable to the general public, and is preferably developed soon, especially considering today's worsening global economy.

In most crime situations, such as kidnapping or abduction, after the victim has a chance to place an emergency call to 911 using the PSU device, the attacker usually forces him or her to move to another location that may be very far away from the original crime scene. In this case, if the law enforcement agencies relying only upon the information of the GPS generated code translated location map which is attached in the initially received PSU emergency e-mail, then they may not find the victim at all since the victim has already been forced to relocate. With the new improved GPS tracking system which uses the PSU device serial number as the new phone dialing number to track the victim's most current location, this problem can be resolved.

After the attack, if the suspect robs the PSU device from a victim for his own use, then the police would have a good opportunity to capture him by tracing the location of the PSU device. However, if the suspect threw the PSU device away while forcing the victim to move, then the police would not be able to find the new location of the victim so easily. In this case, if the victim happened to carry another PSU device whose serial number has been recorded in the “Secondary PSU serial number” field on the “Registration screen panel” by the user, the police may still have a chance to find the new location of the victim by tracing the secondary PSU device, which might be hidden in a pocket of the victim's inner clothing not easily discovered by the perpetrator. If a PSU user really feels that it is necessary to carry an extra PSU device for protection, then it is suggested that he or she might consider carrying a simplified model PSU device because that is an inexpensive tiny device which not only has full GPS tracking functionality but also easy to be hidden in a wallet, a cigarette box, or in a inner shirt pocket close to the body. The “Secondary PSU serial number” is an optional field on the “Registration screen panel” because carrying a secondary PSU device for protection is an extra cautious choice for some people which may not be necessary for everybody. It is assumed that both the primary and secondary PSU devices are owned by the same person. Thus the date of birth field for the secondary PSU device must contain the same birth date information as the primary PSU device. Otherwise the GPS tracking function for the secondary PSU device will not work because the police “GPS Tracking Machine” device uses the PSU e-mail to obtain the secondary PSU device serial number information plus the birth date code specified for the primary PSU device to generate a default GPS tracking passcode to track the location of the secondary PSU device that is currently carried by the PSU user. However, if a family member knows the passcode of the victim's secondary PSU device, then he or she may assist the law enforcement agencies to search for the location of the victim if the victim specified a different birth date on the secondary PSU device.

Note that the new GPS tracking system to track the location of victim's PSU device can be functional only when the power source of the victim's PSU device is on. Therefore, it is highly recommended that PSU users need to be aware that their PSU devices must always be kept turning on. Since the battery is so important to the PSU device, a small and low cost solar battery is recommended to be implemented in the PSU device as a backup in case that the regular battery is drained. When the PSU user sees the red warning light is on, he or she should recharge the battery immediately to avoid the GPS tracking function from failing suddenly which might put his or her life at risk when an emergency occurs.

In one embodiment, the serial number of a PSU device is a 13 or 14 digit string that may contain a three-digit country code, a two-digit year code, a two-digit manufacturer code, a one-digit device model code, one-digit device type code, and the rest of the digits code for the PSU unique serial code assigned by the manufacturer for that model in a year. The serial number of the PSU device is absolutely a unique number in the world because it has a country code which is different for each country. Unlike U.S. social security numbers, the PSU serial number would never need to be recycled or reused by a manufacturer produced new PSU device each year because it contains a two-digit year code. Since the total of the existing regular phone numbers in United States, for example, has been assigned to many home phones, various cellular phones, and other devices. It will soon become not large enough for distribution in the existing phone communication system if the population in United States keeps on growing. Since the phone number dialing system to be used in one country may not be workable in other countries, the unique serial number of the PSU device is the best choice to be used for a global GPS tracking function because none of the existing phone number dialing systems in any countries, including the phone number dialing system in United States, is suitable for international use.

There will be only three models of the PSU device provided by the present invention, thus if we reserve two digits in the PSU device serial number as the representation of a device model and device type for the GPS tracking function, then it would allow many other similar GPS tracking devices like the PSU device to be created which might also need to use this new PSU phone number dialing system in the future. Since the basic model and the simplified model of the PSU device are not the cellular phone and they do not need a regular phone number, a new PSU phone number dialing system must be created in order to allow the new GPS tracking function to be applicable to these two PSU models. Currently this new PSU phone number dialing system with the PSU serial number as the new phone dialing number does not exist yet. However, once it is created it can be implemented in the PSU wireless communication systems in all nations worldwide.

This new PSU phone number dialing system can be dedicated only for the new GPS based people tracking system and it should coexist with the regular phone number dialing system. As a matter of fact this new PSU phone number dialing system and the existing regular phone number dialing system can be combined to share the same hardware components and same portions of the software programs that can be used to process both the existing phone numbers and the new type of phone numbers at the same time. The new type of phone number that uses the PSU device serial number is always followed by a plus-sign “+” and a “GPS tracking passcode”. When a PSU device receives a GPS tracking request sent from another PSU device that belongs to either the victim's family or a law enforcement agency, instead of responding with ringing tone for a phone call, it will send an e-mail with a GPS generated code back to show the victim's most current location. The GPS tracking request e-mail response from a victim's PSU device will be delivered over the Internet to the primary e-mail address which is pre-registered in the PSU device of the GPS tracking requester which could be either the victim's family member or a law enforcement agent.

In one embodiment, this new PSU phone number dialing system may be designed to replace the existing regular phone number dialing system when the device serial number without a plus-sign “+” and a “GPS tracking passcode” is dialed. In this case, instead of responding with the GPS generated code in an e-mail, the receiver's PSU device will respond with a ringing tone ready for the phone conversation just like a regular cellular phone. The difference of the regular phone call and the GPS tracking request on the advanced model PSU device relies upon whether a passcode has been specified in the new phone dialing number or not. Therefore, this new PSU phone number system has a great potential to completely replace the existing regular phone number dialing system and become the universal phone number dialing system that can be used for both regular phone conversation and the new GPS tracking for every country if all regular cellular phones are upgraded to PSU phones.

The PSU wireless communication system that involves the use of the PSU device cannot totally replace the existing 911 system but must coexist with the 911 system and only be used as a supplemental system for the 911 call. For example, a cellular tower that relays the normal cellular phone messages could also be employed to relay the signals transmitted from the PSU device, and the cellular phone base stations could also be employed as the voice-image message receiving stations. For situations that are thought to be not life threatening such as a family illness, a stolen car, a call for an ambulance at an accident scene, or a house fire, etc. a person should directly dial 911 instead of using the PSU device to contact 911 for help. In some cases, the caller may obtain assistance from a 911 rescue team faster by direct dialing 911 than by placing a PSU device emergency call. In general, a PSU device e-mail message is preferred over a direct phone call to 911 when the user's freedom is restricted in some way because of a dangerous situation. For instance, the user may want to be unobtrusive and not draw attention when in a group of people that are threatened. However, the user could still transmit background sound and images by quietly pressing and releasing the SOS push button 14. This security feature is also preferred over a direct call to 911 when the time for an emergency call is limited to a few seconds. In some cases, there may be enough time for the PSU user to send out repeated emergency messages within a 5 to 10 second period to catch the 911 rescue team's attention. Under extremely dangerous situations, the user may not be able to provide the rescue team with all of the desired information for a quick response. However, in many cases partial information such as a voice message only or an image message only might be preferable to an inability to send a 911 center any information at all. Therefore, it is very important that a user should always carry the PSU device for their own protection because the present invention can provide an alternative choice to contact 911 during emergency situations.

One advantage of the present invention is that people who are in extremely dangerous situations without enough time or freedom to connect to a 911 center by using a home phone or a regular cellular phone would be able to send a PSU voice or image message simply by pressing a push button to record the information, and release the button to send a message. This entire sequence could be accomplished in matter of a few seconds.

With the availability of this versatile device, people should not feel defenseless anymore while facing potential attackers or dangerous situations. The national crime rate should be greatly reduced due to the contribution of this new PSU wireless communication system if a substantial number of people take advantage of this new device for their protection.

Similar to the existing cellular phone communication system, the PSU device also depends on available phone towers to relay signals and an appropriate number of base stations to enable an adequate response to messages. Some locations in the United States are still isolated because of a lack of phone towers and/or base stations. At some locations such as the interior areas of large train stations, supermarkets, tall buildings, underground train tunnels, cruise ships, etc. the digital signals cannot be transmitted to a base station due to blockage from concrete walls or lack of electronic equipment to relay the digital signals out of the blocked area, lack of the services from wireless network service providers, or other reasons. Government or private funding is necessary to build an infrastructure to remove those blockages, add more electronic equipment to relay the digital signals, and extend the service regions for the wireless network service providers that will cover the entire country and allow all citizens to be protected no matter where they are located. Conceivably, the PSU device could be used anywhere in the world to save lives as long as there is infrastructure in place to support its function. However, an extensive campaign may be necessary to educate other nations to appreciate the power of the PSU device and upgrade their existing wireless communication network systems accordingly so that all the people in the entire world can live a life very safely and peacefully.

It is also anticipated that some cellular phone transceiver towers in this country and others may still operate under an older technology and are capable of providing services only to people with analog cellular phones. Those phone towers might not be able to receive or transmit radio frequencies in digital signal format and are therefore incompatible with the PSU device and the digital cellular phone signal receptions. As a result, the need for regulations to define a standardized national wireless communication network technology will need to be addressed to allow the modern convenience of digital signal processing at phone towers across the country.

Although there are differences between the digital signals sent from the regular cellular phone and from the PSU device, the present invention encompasses an embodiment wherein the FCC or another authority assigns a new range of radio frequency bandwidth specifically selected to accept digital signals transmitted from the PSU devices. This action would assist the base stations to easily distinguish these two types of digital signals for a speedy response to emergency calls.

The PSU wireless communication system relies heavily upon the efficiency of the Internet Service Providers (ISPs) for delivering e-mail messages. Some ISP companies always have poor performance in terms of constantly delaying e-mail deliveries, which is not desirable for emergency calls during extremely dangerous situations. In a preferred embodiment, each voice-image message receiving station may choose a reliable ISP company that allows rapid and uninterrupted delivery of e-mail messages which will in turn guarantee that the PSU wireless communication system will function at an optimum level.

In some situations, the emergency call e-mail file generated by the PSU wireless communication system may be considered as legal forensic evidence of crime, similar to DNA evidence. To prevent someone from producing fake evidence by using a PSU device that does not belong to the victim, certain actions may be taken. In one embodiment, a PSU unique traceable serial number is assigned to each newly created voice and image e-mail transmitter device in compliance with the manufacturers and the wireless communication regulations of a particular country. As mentioned previously, this PSU device serial number may contain a country code, a specific PSU manufacturer code, the year that the device is made, the model and type code of the device, and a unique serial number assigned by that PSU manufacturer. This serial number may be attached to each device permanently so that it cannot be removed or altered manually by the user. In one aspect, the PSU device serial number code is transmitted in the PSU e-mail together with the pre-registered personal information such as the user name, gender, date of birth, primary e-mail address, home address, home phone number, type of spoken language, and face photo picture, etc. as well as the timestamp of the date and time that the message was sent from the caller and received by the voice-image message receiving station. The registration of the device serial number and the associated user name by the phone company is required when the user applies for a regular phone number for the advanced model PSU device just like a regular cellular phone. It is anticipated that some guidelines provided to the law enforcement personnel and prosecutors regarding on how to investigate and legally present the forensic evidence created by the PSU device and the PSU wireless communication system might be needed in the future.

Due to the significant value of the forensic evidence in the PSU e-mail produced by the PSU device, each of the local voice-image message receiving stations should be equipped with sufficiently large storage space to maintain all received message files and generate a catalog for future reference to enable ready access to a particular file. This embodiment may encompass a new software system that allows a capability to easily search for and retrieve information in the archived PSU emergency e-mail files from the storage space.

In another aspect, the PSU wireless communication system may be designed so that messages are traceable like phone records available from regular phone communications. Thus, whenever a PSU e-mail is delivered by a local voice-image message receiving station, that station may be held responsible for recording in a computer database the PSU device serial number, the time that the PSU e-mail was received and delivered, and the GPS generated location code of the caller. The secret code and size code associated with each PSU e-mail as described previously will also be recorded in the database log entry when the e-mail was delivered, which can guarantee that no one would have any chance to break the law by perjuring the PSU e-mail and create fake forensic evidence. If a PSU device is robbed or stolen from a victim who has been murdered, kidnapped, or harmed in other ways, then the law enforcement agencies may investigate the records from a database to trace the victim's PSU device usages. The present invention also anticipates that the police may investigate the content of a suspicious PSU e-mail sent from a missing PSU device. The investigative capability described herein may lead to the capture of a suspect based on the information from the traced PSU device serial number records and the intercepted suspicious e-mail. As mentioned previously, no one would be allowed taking over the ownership of a PSU device without the permission from the original owner because all PSU devices are personalized and are traceable.

The new software program of this system has the capability to access the GPS location code cross reference charts to find the latest e-mail address of the closest police station, a 911 center, or participating volunteer or professional emergency responder in the country based on the GPS location codes. The list files are stored in a national database at the central process server and the contents in the files can be updated by an operator using a proper command entered on a program panel whenever an e-mail address is necessary to be updated in the files. These list files are centralized for the entire country so that no two operators can update these files simultaneously. It is understood that only the authorized operators of the PSU wireless communication system can access these list files to update the contents. If the e-mail account of a police station or a 911 center is discovered to be sabotaged by a hacker and need to be restored or if the parts of the hardware or software is found to be damaged and need to be repaired, then an operator must replace the e-mail address name to a new one from the list files immediately in order to keep the PSU emergency responses not interrupted. Meanwhile the e-mail address code of the infected e-mail account will be renamed to prevent any further attacks from the same hacker. Since the content in these list files are very important and critical, a backup copy of each of these list files will be needed for recovery in case that some data in this list files is lost, damaged, or messed up.

Usually the subject field in the newly created PSU emergency e-mail contains a caller's name, and the voice-image receiving station code followed by a timestamp of the date and time that the message was sent from the caller and received by the voice-image message receiving station. The e-mail is always attached with a voice message file, an image message file, and a GPS location map file. Such kinds of PSU emergency e-mail are very difficult for a hacker to massively produce and send to many PSU users as spam over the Internet in an attempt to scare people for fun or crash their computer operating systems with a virus planted in the attached message files. Spamming and spreading computer virus are illegal. When a PSU user receives a fake PSU emergency e-mail and notices that the face photo picture displayed in the contents field of the PSU e-mail does not look like a family member, then he or she should not feel panic initially and should not open any of the attached message files to protect the PC or Mac from being contaminated by virus. Instead, the PSU user should immediately report the incident to a law enforcement agency at a local police station for further investigation. The hackers who constantly send out massive fake PSU emergency e-mails to harm people will be prosecuted severely if they are caught by the law enforcement agencies.

In the future all Internet Web Browsers will need to be upgraded to be able to distinguish between a genuine PSU e-mail and a fake one. If a person receives a PSU emergency e-mail in the Spam box instead of Inbox, then he or she should delete it immediately without opening any of the attached message files in order to protect the PC or Mac from being contaminated with virus.

The information obtained from this PSU wireless communication system should be transferred to the local Amber Alert system automatically, if there is any, immediately after an emergency occurs so that when a kidnapping or abduction occurs the Amber Alert system can broadcast the news on several TV channels without delay. The TV news may display a photo image of the missing child as well as a picture of the suspect that is obtained from the image message file attached to a PSU emergency e-mail. In another aspect, the criminal action video may be shown so that the general public can help to identify the suspect. Currently, it is unknown why every state in United States does not have an Amber Alert system. With the help from the PSU device wireless communication system, the Amber Alert system is expected to become a very popular public service tool in the future and might be expanded to every state in United States. It is expected that many other nations in the world might also be interested in establishing the similar Amber Alert system as in United States if this PSU wireless communication system will be proven to be able to recover missing children who are the victims of the violent crimes very effectively.

Traditionally, the FBI and many other law enforcement agencies, and the Amber Alert system always rely upon the sketches drawn from the descriptions of a suspect by an eyewitness, if they can find one, and the sketches are drawn either by hand or by an electronic device to solve violent crimes. Sometimes they have no other choice but to show the sketched pictures on several TV channels and hope the general public can identify the suspect for them. Although the sketching method might be able to solve some crimes, the success rate of this technique must be quite low. The sketches have a tendency to be inaccurate and unreliable due to the inability of an eyewitness to recall the facial details of a suspect from a stressful encounter. Also, the accuracy of sketches relies upon the interpretive skill of the artist when listening to the eyewitness descriptions. The evidence produced by sketches is definitely not as reliable as the photo pictures taken by a victim or an eyewitness with a device having an external camera, such as in the PSU device.

There is an old saying which says “A picture is worth a thousand words”. It is true because the evidence presented in a photo picture is more convincing than many words which may not be truthful. This saying also indicates that how crucial the PSU device is for public protection as proven by the fact that the FBI and other law enforcement agencies continue to use the primitive and unreliable sketching techniques that are inadequate for solving many criminal cases simply because they are unable to find a better solution such as provided by the PSU device. With the evidence of the photo pictures presented in the image files of a PSU e-mail, the law enforcement agency profilers may have a better chance to solve the criminal cases in a short period of time.

As mentioned before, the major difference between the PSU emergency calls and the conventional emergency 911 calls from a home phone or regular cellular phone is that the users do not need to wait for the verbal response from a 911 operator when they place a PSU emergency call because most of the time there is no chance for the victim to wait for a response at all when an emergency occurs. The external camera component of the PSU device can take a photo picture of the potential attacker as a forensic evidence for the future prosecution while the conventional 911 phone call method cannot. The PSU emergency e-mail message can be transmitted to multiple recipients including the law enforcement agencies simultaneously to notify all of them about the emergency situation. The conventional emergency 911 phone call has no such capability.

There are many advantages of the PSU device and the PSU wireless communication system other than sending emergency calls and providing forensic evidence of violent crimes. For example, if a person who is carrying the PSU device is an eyewitness of a hit and run accident, then he or she may help the police to solve the crime by using the PSU device to take a photo image of the perpetrator's car license plate number. If a person is accidentally trapped underneath a collapsed building or injured or disabled in a remote area, then he or she may use the PSU device to continuously send out messages to ask for help. The PSU device certainly can help the victims to communicate with a 911 rescue team and guide them to locate the accident location much easier and faster than other devices and thereby save many people's lives.

In one embodiment, the PSU device may be designed to connect with a regular PC or Mac through the Universal Serial Bus (USB) cable line and perform the two-way voice and image e-mail communication function over a Internet network. When the PSU device is connected to a regular PC or Mac via a USB data cable line, the antenna function of the PSU device will be automatically disabled. In this embodiment, a special software program similar to the one that is installed at the voice-image message receiving stations will necessarily be installed in the PC or Mac. When the push button 14 (or 42) of the PSU device is released, the digital signal string that contains the recorded voice and image messages will be sent through USB data line to the PC or Mac operating system. Then the software installed in the PC or Mac will parse the digital signal string and create the voice and image message files in a “.wav” and “.jpeg” format which will be attached to the PSU e-mail and sent to the pre-defined destination e-mail addresses over the Internet network. The three-way toggle switch 17 may be employed by the user to send a voice message only, send a photo image message only, send both voice and image messages, or send a video message to other PC or Mac users. Thus, the PSU device may be served as a front-end gate of a PC or Mac for the users to create voice, image, or video e-mail to communicate with other PC or Mac users over the Internet network.

In another embodiment, the PSU device may be designed to connect to an alarm device and a movement sensor which can be used in the business office or house as a surveillance device. To offer protection while at home, the PSU device may be set to private use mode and the three-way toggle switch may be set to send image or video messages mode. Both the PSU device and the movement sensor may be hung on the wall in a room of an office, a store, or a house. When a burglar enters the dark room during the night, his movement will trigger the sensor to turn on the room light. The alarm attached to the movement sensor will be activated automatically and its sound can warn the house owner and scare the intruder away. Optionally, a silent alarm with an adjustable sound volume can be installed in a control room of the office or store, or in a bedroom of a house if the office manager, a store or house owner prefers to be warned quietly. Meanwhile, the movement sensor also triggers the PSU device to take a picture or a video of the intruder in the room. The picture or the video being taken will be sent to the e-mail address of the office manager or a store or house owner over the Internet to produce evidence of a crime. If any emergency occurs during the burglary, the office manager or the store or house owner should immediately use a regular phone to dial 911 for help. Thus, the PSU device may serve as life-saving device during the day and offer the office, store, or household surveillance function during the night. Of course, this office, store, and household surveillance feature may also function during the day. Since the movement sensor and alarm device are believed to already exist, the design of these elements will not be described herein.

Some of the additional features of the PSU device as described previously are in fact not essential to the emergency calls and thus may be excluded from the design of the PSU device. To make the PSU device really affordable, the manufacturers may consider producing the following less complicated embodiments of the PSU device to reduce its cost:

A first embodiment of a low cost PSU device encompasses the voice-image messaging as described previously having the viewing screen having only the pre-registration and the registration verification capabilities, and it does not allow the PSU user to input an e-mail addresses or a phone numbers for private calls. There is no key button on the PSU device for the PSU user to change from emergency use mode to private use mode, and the SOS push button can only be used for sending emergency calls and it is the lowest cost basic model of the PSU device.

A second embodiment of a low cost PSU device encompasses the voice-image messaging as described previously without providing the PDA-like features because those additional functions can increase quite a lot of the cost of the PSU device and they cannot provide any contribution to the function related to emergency calls.

A third embodiment of a low cost PSU device encompasses the voice-image messaging as described previously without providing a SDHC memory chip for the digital camera function in the basic model of the PSU device for storing the photo pictures because adding the SDHC chip to the PSU device can increase cost substantially.

A fourth embodiment of a low cost PSU device encompasses the voice-image messaging as described previously without providing an alarm device equipped on the external parts or on the PSU device for saving the cost.

A fifth embodiment of a low cost PSU device encompasses the voice-image messaging as described earlier except without the two-way voice and image e-mail communication capability on the PSU device using the Web Browser software like the Windows phone over the Internet.

A sixth embodiment of a low cost PSU device encompasses the voice-image messaging as described earlier except without the two-way voice and image e-mail communication capability on PC or Mac through the USB cable connection over the Internet.

A seventh embodiment of a low cost PSU device encompasses the voice-image messaging as described earlier except without the additional GPS generated code translated 2-D location map displayed on the PSU viewing screen, and the PSU user may only check the attached GPS 2-D map file in the PSU emergency e-mail to search for the location of a victim's when an emergency occurs.

An eighth embodiment of a low cost PSU device encompasses the voice-image messaging capability as mentioned previously except the keypad is simplified by combining the numerical and alphabetical key buttons similar to a home phone keypad.

A ninth embodiment of a low cost PSU device comprises the voice-image functionality as described earlier wherein a short wire is used instead of wireless technology to connect with the external pinhole external camera and external microphone devices. This embodiment also encompasses a PSU device that provides either voice or image e-mail function and has the connection to either the external camera or external microphone but not both. In this case, the three-way toggle switch accessory component for selecting a message type is not required.

A tenth embodiment of a low cost PSU device comprises the voice and the image functionality mentioned previously with the added limitation that the device has essentially the same width and length dimensions as a credit card. This version is small enough to be carried in a shirt pocket and may have a built-in microphone with a tiny external pinhole camera like a button connected to the device by a wire or wirelessly. The button shape external camera may be attached to a shirt with a pin. Optionally, the external camera may be hand held and in the shape of a pen that has a clip and a push button. The clip may serve to attach the external camera to a shirt pocket and the push button may be used to take a photo picture by pointing the tip of the pen towards a particular object.

An eleventh embodiment of a low cost PSU device comprises at least one medium size memory chip that is large enough to produce the digital signal string for the software program installed at voice-image message receiving station to create the voice and image message files in a “.wav” and “.jpeg” format. It does not contain a large sized memory chip and cannot create the video message file in a “.mpg” or “.avi” file format due to the small memory can save the cost of the PSU device.

A twelfth embodiment of a low cost PSU device encompasses the voice-image messaging as described previously without providing a solar battery as backup because adding an extra battery can increase the cost of the PSU device.

Without providing the two-way voice communication function like the cellular phone, the basic model PSU device does not need to have a regular phone number. If a user does not use the PSU device as a cellular phone and did not register for a phone number from the phone company, then the PSU user does not need to pay any monthly phone service fees. Thus, the basic model PSU device which does not have the cellular phone capability may be just dedicated for emergency calls through e-mail over internet and it is most suitable for young children to use.

Since the PSU device is a critical life-saving tool, parents should always check for their children that the battery of their PSU device is sufficiently recharged to provide emergency calls anytime during the day. Furthermore, parents should teach their children that whenever they are alone and feel threatened by someone they should not hesitate to use the PSU device to take a photo image of the potential attacker and send a message either to home or to a 911 center.

The basic model PSU device can provide the desired benefits to most people who wish to use the PSU device as a low cost life-saving tool for emergency calls. However, those who frequently use a regular cellular phone would more likely favor one or more of the more expensive features provided in the advanced model in order to optimize the performance of the PSU device. The advanced model PSU device can provide all the functions that a regular cellular phone has provided. However, there are many new features provided by the PSU device that cannot be found in a regular cellular phone. The new features disclosed in the present invention includes: (1) a security system including a “Registration update passcode” and “GPS tracking passcode” to prevent unauthorized persons from updating the personal information on the PSU device and tracking the location of the PSU device; (2) a portable surveillance function with photo image e-mail messages; (3) the capability of voice, image, and video message broadcasting function; (4) a traceable device serial number identification in a national database; (5) the hyperlink icon in all private call e-mails that allows the recipient to forward the message to a local police and be treated as an emergency call; (6) the GPS location code cross reference charts for routing an emergency e-mail to the closest 911 center based on the GPS location code; (7) a capability to provide a function similar to digital camera or camcorder; (8) a message type selection function by a three-way toggle switch; (9) an emergency call e-mail records tracking system; (10) a PSU e-mail secret code and size code for maintaining original forensic evidence such as pictures and voice files; (11) a fast voice and image e-mail message delivering system over Internet for emergency calls; (12) an advanced function of a two-way voice and image e-mail communication for the PSU device and for a PC or Mac; (13) a household surveillance device and alarm system; (14) a new GPS based people tracking function similar to the GPS tracking function applied to Smartphone; (15) two types of the new “GPS Tracking Machine” upgraded from the regular “Auto GPS Navigator”; (16) a new PSU phone number dialing system using the PSU device serial number as phone dialing number; and (17) the entire system that combines the PSU device and wireless communication network with the new software and the Internet e-mail for a life-saving function, etc. Each of these new features provided by the PSU wireless communication system is an advantage over state of the art communication devices.

Components of a wireless communication system have been widely developed during the past several decades and are found in technologies such as radio, television, cellular phone, GPS chipset, and the Internet network for improved communication and entertainment capability. Since the technologies required for developing many devices for wireless communication industries have advanced rapidly in recent few years, now is really the time to seriously consider the development of a very useful and meaningful new application that combines the three major applications of the cellular phone, GPS chipset, and Internet network together to enhance the security and safety of human lives. Violent crimes, such as kidnappings, abductions, and murders, are common problems to all nations in the world and can happen to anyone in any country at any time. Therefore, the need for better protection should be a global issue and not just a local problem of a single country. Now is the time to start developing a portable surveillance system using the PSU device that is disclosed in the present invention because the PSU device is the crime stopper which can prevent various violent crimes from occurring and it can bring safety and security to the world to make all people live peacefully in the future.

The PSU wireless communication system which has the portable surveillance function provided by the PSU device can protect many people and has been desired by a lot of people for many years. It should not be a system that is available only in a person's imagination, in the criminal detective stories, or in the science fiction movies anymore because all the technologies required to build the components of the PSU device for the PSU wireless communication system are already available for reference. We anticipate that many scientists, engineers, and programmers of wireless communication companies and the “Auto GPS Navigator” manufacturing companies will be interested to do more researches on the applications of the PSU wireless communication system and the PSU device defined herein. Cellular phone manufacturing companies are also encouraged to upgrade their products to the next generation cellular phones with the PSU device component described herein so then can offer enhanced personal protection.

The following is the summary of the new features and the improvements disclosed in the present invention which were not included in the previous invention document of U.S. Pat. No. 7,751,534.

(a) The Triangular method for tracking the caller's location has been replaced with the modern GPS based people tracking method. A new GPS tracking system using PSU device serial number as the phone number in the new PSU phone number dialing system has also been disclosed.

(b) Two new screen panels called the “Registration screen panel” and “Verification screen panel” have been introduced in the present invention. These two panels can be used for the registration of the PSU user's personal information and for verifying the authentication to update the personal information. In the registration panel, the PSU user may specify two passcodes for obtaining the authorization to update personal information and for the GPS tracking of a PSU device. The verification panel also contains a function to allow a police station to send notify e-mail to a PSU user who lost a PSU device.

(c) All the PSU devices can be personalized with pre-registered personal information, and each PSU device is traceable by using the GPS tracking function. There is a section on the verification screen panel which allows the PSU user to be able to receive a notify e-mail from a police station to retrieve a lost PSU device

(d) The “Default” option was removed from the viewing screen, and if a PSU user and his or her parents and all other family members do not have a PC or Mac, and none of them or any friend has subscribed to an e-mail account, then the primary e-mail address field on the “Registration screen panel” may be left blank, which is equivalent to the “Default” option.

(e) The key buttons on the keypad have been rearranged. A new key button for updating the registration panel and for the verification screen panel operations has been added. The top surface of the key button has been changed to a slightly curve shape from the flat shape.

(f) The concept of “Portable Surveillance Function” is introduced in the present invention. The code “PSU” as “Portable Surveillance Unit” is provided for the voice and image e-mail transmitter device and the code “PSS” is provided for the PSU wireless communication system. These two codes have been selected as the trademark-like synonyms for the present invention.

(g) A definition is provided for various types of the GPS location code cross reference chart files in the national database which contains the GPS location code corresponding to the closest police station, local 911 center, participating volunteer or professional emergency responder, local hospital, senior citizen health care center, or any participating life-alert or medical-alert center, etc. for routing the PSU emergency e-mail files.

(h) The internal built-in clock of the PSU device can be synchronized with the system clock installed at the central process server, and it never needs manual adjustment. A solar battery can be added to the PSU device as the backup of power source.

(i) In addition to the e-mail items and phone number items, the “group item” which combines several e-mail and phone items together, and the “GPS tracking item” which can be used for tracking the location of another PSU device are also valid items for the PSU device.

(j) A simplified model PSU device was added for tracking the valuable assets. It can also be used as the secondary PSU device for an extra cautious protection function.

(k) Two versions of the “GPS Tracking Machine” device were added and run under the new PSU phone number dialing system using the PSU device serial number as the phone number for tracking the locations of missing persons who may be the victims of violent crimes. One is the police version device which has a police badge reader and a scanning reader, and the other is a civilian version device which does not have a reader and is for the general public to use. Both versions “GPS Tracking Machine” are upgraded from the existing regular “Auto GPS Navigator” device.

(I) Application of the PSU wireless communication system can be extended to several different emergency help areas such as the urgent assistance for senior citizens and communication among soldiers on a battlefield. A pendant or watch can be wirelessly connected to the PSU device to allow senior citizens to contact a participating life-alert or medical-alert company for help. The PSU device can also be used for voice and video message broadcasting functions in government or business offices.

(m) The top surface of the SOS push button has been modified to a slightly curved shape instead of straight flat shape to more easily send an emergency message from a PSU device.

(n) In addition to the secret code that can be used to combine the PSU e-mail file with its associated message files, the size code of all these files will also be imbedded. This secret code and size code will be recorded in the PSU wireless communication system log entry to prevent anybody from perjuring the e-mail and creating fake forensic evidence.

(o) Added the detailed descriptions of each field for the PSU emergency e-mail in the present invention. Allows the PSU users to broadcast the voice or video messages to multiple e-mail and phone recipients at the same time when the PSU device is used in the private use mode. Provided a “Subject screen panel” to allow the PSU users to create a short subject in the e-mail to be sent.

The innovative features of the PSU device described herein should be recognized by those skilled in the art to be readily adaptable to the next generation of cellular phones. Therefore, one or more of the unique features previously described may be added to current cellular phone technology as an upgrade.

While the present invention has been particularly shown and described with reference to, the preferred embodiment thereof, it will be understood by those skilled in the art that various changes in form and details may be made without departing from the spirit and scope of the present invention.

We claim:

1. A communication device also known as a voice and image e-mail transmitter device, or a portable surveillance unit (PSU) device, for sending information in digital signal string format wherein said information includes an e-mail address, user name, a device serial number, and one or both of a voice message and an image, said device comprising:
a base portion comprised of a GPS chipset, a keyboard for data entry, a key button pad for selecting different functions, a three-way toggle switch for message type selection, and a push button for sending voice and image signals, voice message with no image, or image with no voice message that are subsequently converted to one or more message files at a receiving station, said push button is pressed to record a message and released to send a message to a pre-determined e-mail addresses; and a cover portion comprised of a viewing screen, a center position of the push button is used for private calls and either of two end positions are used for emergency calls.

2. The communication device of claim 1 further comprised of an internal central process unit (CPU), static and dynamic memory chips, an internal clock, and a battery in the base portion.

3. The communication device of claim 2 wherein the CPU is used to convert voice input data and image input data into digital signals, the dynamic memory chips are used for storing converted digital signals, the static memory chips are used for storing pre-registered personal information, the GPS chipset generates a location code of the PSU device for GPS tracking purposes, the internal clock is automatically synchronized with a system clock and generates a time code required for message transmission, and the battery provides a power source, and may have a solar battery as a backup, and is an essential component which enables continuous capability for emergency calling and GPS tracking functions.

4. The communication device of claim 1 wherein the base portion is further comprised of a wire that connects the PSU device to an external camera and/or external microphone device that is attached to an ornament or an article of clothing worn by a user, and a push button that is pushed in to collect image data from the external camera device and voice input from the external microphone and released to transmit the voice and image data in a digital string format to a voice-image message receiving station through an antenna connected to or imbedded in the base portion.

5. The communication device of claim 1 wherein a secret code and a size code are embedded in the emergency e-mail message and the message files to maintain the message in its original form so that associated e-mail and message files may be kept together as a legal document for forensic evidence.

6. The communication device of claim 1 wherein a “Group item” may be selected from the voice and image e-mail transmitter device to perform a voice or video broadcasting function which is an alternative way for sending an urgent message to multiple recipients over an Internet network.

7. The communication device of claim 6 wherein the PSU device is connected to a PC or Mac via a USB data line to enable a massive voice or video e-mail message to be sent from the PC or Mac to one or more recipients over the Internet network.

8. The communication device of claim 1 wherein a “Registration screen panel” for a pre-registry of PSU user's personal information and a “Verification screen panel” for verifying an authentication to update personal information are available on the cover portion, the “Registration screen panel” is used to specify two special passcodes for obtaining authorization to update personal information and for tracking the PSU device.

9. The communication device of claim 1 wherein a “GPS Tracking item” is defined with a passcode on the voice and image e-mail transmitter device to enable sending GPS tracking request to search for the location of a PSU user.

10. The communication device of claim 8 wherein a secondary PSU Serial number option in the “Registration screen panel” is employed for extra protection.

11. The communication device of claim 1 wherein a “notify e-mail” option in a “Verification screen panel” in the cover portion allows users to retrieve a lost PSU device from a police station or law enforcement agency.

12. A system for sending and receiving voice and image information in digital signal string format, said system comprising:
(a) a portable surveillance (PSU) device for sending information in digital signal string format wherein said information includes an e-mail address, user name, a device serial number, and one or both of a voice message and an image, said PSU device comprises a base portion comprised of a GPS chipset, a keyboard for data entry, a key button pad for selecting different functions, a three-way toggle switch for message type selection, and a push button for sending voice and image signals, voice message with no image, or image with no voice message that are subsequently converted to one or more message files at a receiving station, said push button is pressed to record a message and released to send a message to a pre-determined e-mail addresses; and a cover portion comprised of a viewing screen, a center position of the push button is used for private calls and either of two end positions are used for emergency calls.
(b) at least one cellular phone tower which is at a location that can relay voice and image signals received from the PSU device; and
(c) a software program installed at the central process server in a voice-image message receiving station that can convert voice and image signals from the received digital signal string into one or more message files which are attached in a newly created e-mail and forwarded to one or more pre-defined e-mail addresses.

13. The system of claim 11 wherein the software program converts voice and image digital data transmitted from dynamic memory chips in the PSU device_into a “.wav” or “.jpeg” format.

14. The system of claim 13 wherein the dynamic memory chips have a capacity of about 4 GB or larger to enable a conversion of transmitted video digital data into a “mpg”, or “.avi” file format.

15. The system of claim 11 wherein the voice and image e-mail transmitter device is further comprised of functionality that enables two-way voice and image e-mail communication over the internet, and may also be connected to a PC or Mac via a USB data line to achieve voice and image e-mail communication from the PC or Mac over an Internet network.

16. The system of claim 11 wherein the voice and image e-mail transmitter device and an alarm device are connected to a movement sensor and are affixed to a wall or another structure for office and household surveillance use.

17. The system of claim 11 wherein a new PSU phone dialing system using the PSU device serial number of the voice and image e-mail transmitter device as the phone dialing number followed by a user specified “GPS tracking passcode” is used to enable a GPS based people tracking method for locating a missing person.

18. The system of claim 17 wherein a “GPS Tracking Machine” with a 2-D GPS map monitor upgraded from the “Auto GPS Navigator” is used to send a GPS tracking request within the new PSU phone number dialing system to track the location of a missing person.

19. The system of claim 18 wherein the police version “GPS Tracking Machine” comprises a police badge reader and scanning reader for use by law enforcement agencies.

20. The system of claim 18 wherein the civilian version “GPS Tracking Machine” is designed for general public use and does not contain the police badge reader and scanning reader.
